(19) United States
(12) Patent Application Publication
(10) Pub. No.: US 2025/0374294 A1
(43) Pub. Date: Dec. 4, 2025

(54) NETWORK CONFIGURED MULTI-STAGE PHYSICAL DOWNLINK CONTROL CHANNEL (PDCCH) BLIND DETECTION PROCEDURE

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Wei YANG, San Diego, CA (US); Jing JIANG, San Diego, CA (US); Yan ZHOU, San Diego, CA (US); Jing SUN, San Diego, CA (US); Gabi SARKIS, San Diego, CA (US); Mostafa KHOSHNEVISAN, San Diego, CA (US); Kangqi LIU, San Diego, CA (US)

(21) Appl. No.: 18/732,339

(22) Filed: Jun. 3, 2024

(51) Int. Cl. H04W 72/232; H04L 25/02

(52) U.S. Cl. CPC H04W 72/232; H04L 25/0238

(57) ABSTRACT

Various aspects of the present disclosure generally relate to wireless communication, and to network configured multi-stage physical downlink control channel (PDCCH) blind detection. For example, a network node causes a user equipment (UE) to perform a two-stage PDCCH blind detection procedure by transmitting an indication of the two-stage procedure to the UE. During a first stage of the two-stage procedure, the UE measures, for each PDCCH candidate of a first PDCCH candidates, a demodulation reference signal (DMRS) associated with the PDCCH candidate. During a second stage of the two-stage procedure, the UE performs a blind detection operation on at least one PDCCH candidate of second PDCCH candidates. The second PDCCH candidates include members of the first candidates selected in accordance with the measurements. Performance of the two-stage procedure identifies a PDCCH candidate, from the second set of PDCCH candidates, via which the UE receives control information from the network node.

### FIELD OF THE DISCLOSURE

Aspects of the present disclosure relate generally to wireless communication systems, and more particularly, to a network configured multi-stage physical downlink control channel (PDCCH) blind detection procedure in wireless communication systems.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies, such as 6G, may be introduced to further advance mobile broadband evolution.

To support data communication or services in a 5G NR wireless communication system, a network node such as a base station may send downlink control information (DCI) to a UE to indicate a wireless channel via which the UE is to receive downlink data or a service from the network node. This DCI is carried in a physical downlink control channel (PDCCH), which represents an area in a search space (i.e., wireless resources in a resource grid) where the UE is to monitor to receive the DCI via the PDCCH. Because some DCI can be communicated before a direct connection is established between the UE and the network node, the UE may perform a PDCCH blind detection procedure on a variety of PDCCH candidates in various monitoring occasions and over various control resource sets (CORESETS) to search for the PDCCH. As part of the PDCCH blind detection procedure, the UE performs channel estimation and then attempts to fully decode each candidate PDCCH using a location, structure, and scrambling code to determine if a cyclic redundancy check (CRC) portion is capable of being unscrambled using an identifier associated with the UE. Because there can be multiple search spaces for the UE to monitor in one time slot, performing the PDCCH blind detection procedure can result in use of significant processing resources and power consumption. At higher frequency ranges, such as the “millimeter-wave band” and higher frequency bands which are associated with shorter time slots, performance of a large quantity of PDCCH blind detection operations during the same time period also becomes challenging. However, reducing the number of candidate PDCCHs available to UEs can result in blockages if the quantity of available PDCCH candidates is insufficient to support the number of UEs served by the network node.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a user equipment (UE) for wireless communication. The UE includes a processing system that includes one or more processors and one or more memories coupled with the one or more processors. The processing system is configured to cause the UE to receive, from a network node, an indication to the UE to use a two-stage physical downlink control channel (PDCCH) blind detection procedure. The processing system is also configured to cause the UE to perform, in accordance with receiving the indication, the two-stage PDCCH blind detection procedure. The performance of the two-stage PDCCH blind detection procedure includes measuring, in a first stage of the two-stage PDCCH blind detection procedure, for each PDCCH candidate of a first set of PDCCH candidates, a demodulation reference signal (DMRS) associated with the PDCCH candidate. The performance of the two-stage PDCCH blind detection procedure also includes performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. The processing system is further configured to receive, from the network node, control information via a PDCCH candidate, from the second set of PDCCH candidates, in accordance with the performance of the blind detection operation on the PDCCH candidate.

Some aspects described herein relate to a method of wireless communication performed by a UE. The method includes receiving, from a network node, an indication to the UE to use a two-stage PDCCH blind detection procedure. The method also includes performing, in accordance with the indication, the two-stage PDCCH blind detection procedure. The performance of the two-stage PDCCH blind detection procedure includes measuring, in a first stage of the two-stage PDCCH blind detection procedure, for each PDCCH candidate of a first set of PDCCH candidates, a DMRS associated with the PDCCH candidate. The performance of the two-stage PDCCH blind detection procedure also includes performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. The method further includes receiving, from the network node, control information via a PDCCH candidate, from the second set of PDCCH candidates, in accordance with the performance of the blind detection operation on the PDCCH candidate.

Some aspects described herein relate to an apparatus. The apparatus includes means for receiving, from a network node, an indication to the UE to use a two-stage PDCCH blind detection procedure. The apparatus also includes means for performing, in accordance with the indication, the two-stage PDCCH blind detection procedure. The means for performing the two-stage PDCCH blind detection procedure includes means for measuring, in a first stage of the two-stage PDCCH blind detection procedure, for each PDCCH candidate of a first set of PDCCH candidates, a DMRS associated with the PDCCH candidate. The means for performing the two-stage PDCCH blind detection procedure also includes means for performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. The apparatus further includes means for receiving, from the network node, control information via a PDCCH candidate, from the second set of PDCCH candidates, in accordance with the performance of the blind detection operation on the PDCCH candidate.

Some aspects described herein relate to a non-transitory computer-readable medium that stores instructions that, when executed by one or more processors, cause the one or more processors to perform operations. The operations include receiving, from a network node, an indication to the UE to use a two-stage PDCCH blind detection procedure. The operations also include performing, in accordance with the indication, the two-stage PDCCH blind detection procedure. The performance of the two-stage PDCCH blind detection procedure includes measuring, in a first stage of the two-stage PDCCH blind detection procedure, for each PDCCH candidate of a first set of PDCCH candidates, a DMRS associated with the PDCCH candidate. The performance of the two-stage PDCCH blind detection procedure also includes performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. The operations further include receiving, from the network node, control information via a PDCCH candidate, from the second set of PDCCH candidates, in accordance with the performance of the blind detection operation on the PDCCH candidate.

Some aspects described herein relate to a network node for wireless communication. The network node includes a processing system that includes one or more processors and one or more memories coupled with the one or more processors. The processing system is configured to cause the network node to transmit, to a UE, an indication to the UE to use a two-stage PDCCH blind detection procedure. The processing system is also configured to cause the network node to transmit, to the UE, and in accordance with a first stage of the two-stage PDCCH blind detection procedure, one or more DMRSs associated with a first set of PDCCH candidates of the first stage. The processing system is further configured to cause the network node to transmit, to the UE, and in accordance with a second stage of the two-stage PDCCH blind detection procedure, control information via a PDCCH of a second set of PDCCH candidates identified from the first set of PDCCH candidates at the UE in accordance with the second stage.

Some aspects described herein relate to a method of wireless communication performed by a network node. The method includes transmitting, to a UE, an indication to the UE to use a two-stage PDCCH blind detection procedure. The method also includes transmitting, to the UE, and in accordance with a first stage of the two-stage PDCCH blind detection procedure, one or more DMRSs associated with a first set of PDCCH candidates of the first stage. The method further includes transmitting, to the UE, and in accordance with a second stage of the two-stage PDCCH blind detection procedure, control information via a PDCCH of a second set of PDCCH candidates identified from the first set of PDCCH candidates at the UE in accordance with the second stage.

Some aspects described herein relate to an apparatus. The apparatus includes means for transmitting, to a UE, an indication to the UE to use a two-stage PDCCH blind detection procedure. The apparatus also includes means for transmitting, to the UE, and in accordance with a first stage of the two-stage PDCCH blind detection procedure, one or more DMRSs associated with a first set of PDCCH candidates of the first stage. The apparatus further includes means for transmitting, to the UE, and in accordance with a second stage of the two-stage PDCCH blind detection procedure, control information via a PDCCH of a second set of PDCCH candidates identified from the first set of PDCCH candidates at the UE in accordance with the second stage.

Some aspects described herein relate to a non-transitory computer-readable medium that stores instructions that, when executed by one or more processors, cause the one or more processors to perform operations. The operations include transmitting, to a UE, an indication to the UE to use a two-stage PDCCH blind detection procedure. The operations also include transmitting, to the UE, and in accordance with a first stage of the two-stage PDCCH blind detection procedure, one or more DMRSs associated with a first set of PDCCH candidates of the first stage. The operations further include transmitting, to the UE, and in accordance with a second stage of the two-stage PDCCH blind detection procedure, control information via a PDCCH of a second set of PDCCH candidates identified from the first set of PDCCH candidates at the UE in accordance with the second stage.

Some aspects described herein relate to a UE for wireless communication. The UE includes a processing system that includes one or more processors and one or more memories coupled with the one or more processors. The processing system is configured to cause the UE to receive, from a network node, an indication to the UE that an identifier (ID) associated with initializing a DMRS sequence is specific to the UE. The processing system is also configured to cause the UE to perform, in accordance with the indication, at least a portion of a PDCCH blind detection procedure on a set of PDCCH candidates. The processing system is further configured to cause the UE to receive, from the network node, control information via a PDCCH candidate, from the set of PDCCH candidates, in accordance with performance of the blind detection procedure on the PDCCH candidate.

Some aspects described herein relate to a method of wireless communication performed by a UE. The method includes receiving, from a network node, an indication to the UE that an ID associated with initializing a DMRS sequence is specific to the UE. The method also includes performing, in accordance with the indication, at least a portion of a PDCCH blind detection procedure on a set of PDCCH candidates. The method further includes receiving, from the network node, control information via a PDCCH candidate, from the set of PDCCH candidates, in accordance with performance of the blind detection procedure on the PDCCH candidate.

Some aspects described herein relate to an apparatus. The apparatus includes means for receiving, from a network node, an indication that an ID associated with initializing a DMRS sequence is UE-specific. The apparatus also includes means for performing, in accordance with the indication, at least a portion of a PDCCH blind detection procedure on a set of PDCCH candidates. The apparatus further includes means for receiving, from the network node, control information via a PDCCH candidate, from the set of PDCCH candidates, in accordance with performance of the blind detection procedure on the PDCCH candidate.

Some aspects described herein relate to a non-transitory computer-readable medium that stores instructions that, when executed by one or more processors, cause the one or more processors to perform operations. The operations include receiving, from a network node, an indication to that an ID associated with initializing a DMRS sequence is UE-specific. The operations also include performing, in accordance with the indication, at least a portion of a PDCCH blind detection procedure on a set of PDCCH candidates. The operations further include receiving, from the network node, control information via a PDCCH candidate, from the set of PDCCH candidates, in accordance with performance of the blind detection procedure on the PDCCH candidate.

Some aspects described herein relate to a network node for wireless communication. The network node includes a processing system that includes one or more processors and one or more memories coupled with the one or more processors. The processing system is configured to cause the network node to transmit, to a UE, an indication to the UE that an ID associated with initializing a DMRS sequence is specific to the UE. The processing system is also configured to cause the network node to transmit, to the UE, and in accordance with a PDCCH blind detection procedure that is associated with the indication, control information via a PDCCH.

Some aspects described herein relate to a method of wireless communication performed by a network node. The method includes transmitting, to a UE, an indication to the UE that an ID associated with initializing a DMRS sequence is specific to the UE. The method also includes transmitting, to the UE, and in accordance with a PDCCH blind detection procedure that is associated with the indication, control information via a PDCCH.

Some aspects described herein relate to an apparatus. The apparatus includes means for transmitting, to a UE, an indication to the UE that an ID associated with initializing a DMRS sequence is specific to the UE. The apparatus also includes means for transmitting, to the UE, and in accordance with a PDCCH blind detection procedure that is associated with the indication, control information via a PDCCH.

Some aspects described herein relate to a non-transitory computer-readable medium that stores instructions that, when executed by one or more processors, cause the one or more processors to perform operations. The operations include transmitting, to a UE, an indication to the UE that an ID associated with initializing a DMRS sequence is specific to the UE. The operations also include transmitting, to the UE, and in accordance with a PDCCH blind detection procedure that is associated with the indication, control information via a PDCCH.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports a network configured multi-stage physical downlink control channel (PDCCH) blind detection procedure in accordance with the present disclosure.

FIG. 5 is a ladder diagram illustrating example wireless communications that support a network configured multi-stage PDCCH blind detection procedure in accordance with the present disclosure.

FIG. 6 is a ladder diagram illustrating example wireless communications that support changing a network configured PDCCH blind detection mode in accordance with the present disclosure.

FIG. 7 is a ladder diagram illustrating example wireless communications that support a network configured multi-stage PDCCH blind detection procedure in accordance with a UE-specific DMRS sequence indication in accordance with the present disclosure.

FIG. 8 is a ladder diagram illustrating example wireless communications that support a network configured single-stage PDCCH blind detection procedure in accordance with a non-UE-specific DMRS sequence indication in accordance with the present disclosure.

FIG. 9 is a flow diagram illustrating an example process that supports a network configured multi-stage PDCCH blind detection procedure in accordance with the present disclosure.

FIG. 10 is a block diagram of an example UE that supports network configured a multi-stage PDCCH blind detection procedure in accordance with the present disclosure.

FIG. 11 is a flow diagram illustrating an example process that supports a network configured multi-stage PDCCH blind detection procedure in accordance with the present disclosure.

FIG. 12 is a block diagram of an example network node that supports a network configured multi-stage PDCCH blind detection procedure in accordance with the present disclosure.

FIG. 13 is a flow diagram illustrating an example process that supports a DMRS sequence specificity-based PDCCH blind detection procedure in accordance with the present disclosure.

FIG. 14 is a block diagram of an example UE that supports a DMRS sequence specificity-based PDCCH blind detection procedure in accordance with the present disclosure.

FIG. 15 is a flow diagram illustrating an example process that supports a DMRS sequence specificity-based PDCCH blind detection procedure in accordance with the present disclosure.

FIG. 16 is a block diagram of an example network node that supports a DMRS sequence specificity-based PDCCH blind detection procedure in accordance with the present disclosure.

### DETAILED DESCRIPTION

Various aspects of the disclosure are described more fully hereinafter with reference to the accompanying drawings. This disclosure may, however, be embodied in many different forms and is not to be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for a network configured multi-stage physical downlink control channel (PDCCH) blind detection procedure for wireless communication systems. Some aspects more specifically relate to a network node configured to cause a user equipment (UE) to perform a two-stage PDCCH blind detection procedure. For example, the network node may transmit an indication to the UE to use the two-stage procedure to cause the UE to perform the two-stage PDCCH blind detection procedure instead of a single-stage PDCCH blind detection procedure. In some implementations, transmission of the indication is triggered by receipt at the network node of capability information of the UE or an indicator of a power mode of the UE. Alternatively, the network node may determine to transmit the indication based on network-side information. During a first stage of the two-stage PDCCH blind detection procedure, the UE is configured to measure demodulation reference signals (DMRSs) associated with each of a first set of PDCCH candidates, which may be preprogrammed at the UE or identified from one or more control resource sets (CORESETS). During a second stage of the two-stage PDCCH blind detection procedure, the UE is configured to perform a blind detection operation on at least one PDCCH candidate of a second set of PDCCH candidates. The second set of PDCCH candidates may be identified based on the UE filtering the first set of PDCCH candidates in accordance with the DMRS measurements. The UE may identify a PDCCH candidate, from the second set of PDCCH candidates, in accordance with performance of the blind detection operations of the two-stage PDCCH blind detection procedure. The UE can then receive and decode downlink control information (DCI) via the PDCCH candidate, which corresponds to a PDCCH assigned to the UE by the network node. In some implementations, the UE is configured to control one or more aspects of a PDCCH blind detection procedure in accordance with an indication, from the network node, as to whether an identifier (ID) associated with initializing a DMRS sequence is specific to the UE. For example, if the network node sends an indication to the UE that indicates that the ID used by the UE to initialize a DMRS sequence is specific to the UE, the UE may perform a two-stage PDCCH blind detection procedure. As another example, if the network node sends an indication to the UE that indicates that the ID used by the UE to initialize a DMRS sequence is not specific to the UE, the UE may perform a single-stage PDCCH blind detection procedure. In other examples, the UE may identify a cyclic redundancy check (CRC) size, a PDCCH blind detection limit, a non-overlapped control channel element (CCE) limit, or another parameter associated with the PDCCH blind detection procedure in accordance with whether or not the ID is specific to the UE. In some implementations, a first indication for the UE to use the two-stage PDCCH blind detection procedure and a second indication that the ID is specific to the UE are the same. Alternatively, the two indications may be distinct, and the UE selects the appropriate PDCCH blind detection procedure and related parameters in accordance with the two indications.

Particular implementations of the subject matter described in this disclosure can be implemented to realize one or more of the following potential advantages. In some aspects, the present disclosure provides techniques for enabling a wireless network, such as a 5G NR wireless network, to configure UEs to perform a multi-stage PDCCH blind detection procedure, as compared to a typical single-stage PDCCH blind detection procedure. The multi-stage PDCCH that uses fewer processing resources and reduces power consumption, or focuses the performance of blind detection operations on PDCCH candidates that are more likely to be an assigned PDCCH, than the typical single-stage PDCCH blind detection procedure. Because measuring DMRSs associated with each PDCCH candidate of the first set of PDCCH candidates uses fewer processing resources and less power than performing blind detection operations on the corresponding PDCCH candidates, the first stage of the two-stage PDCCH blind detection procedure can be performed without significantly increasing processing resource usage and power consumption. In some implementations in which the filtered list is smaller than a blind detection limit, the two-stage PDCCH blind detection procedure can reduce an amount of blind detection operations performed by the UEs, thereby reducing the overall processing resource usage and power consumption as compared to performance of the typical single-stage PDCCH blind detection procedure. Alternatively, the two-stage PDCCH blind detection procedure can be used to filter a larger-sized first set of PDCCH candidates, using less processing and power intensive operations, such as measuring DMRSs, to identify PDCCH candidates (the second set of PDCCH candidates) that are more likely to be the assigned PDCCH candidate. Such filtering of the first set of PDCCH candidates enables the more processing and power intensive blind detection operations to be performed only on PDCCH candidates which are more likely to be the assigned PDCCH, which can improve the accuracy of the two-stage PDCCH blind detection procedure as compared to the typical single-stage procedure. In some implementations, the accuracy or performance of the two-stage PDCCH blind detection procedure is further improved by leveraging an indication of whether an identifier associated with initializing a DMRS sequence is specific to the UE, such that false positives associated with group-assigned identifiers are avoided.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHZ, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHZ bandwidth. Finally, for various deployments transmitting with mmWave components at a TDD of 28 GHz, subcarrier spacing may occur with 120 kHz over a 500 MHZ bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

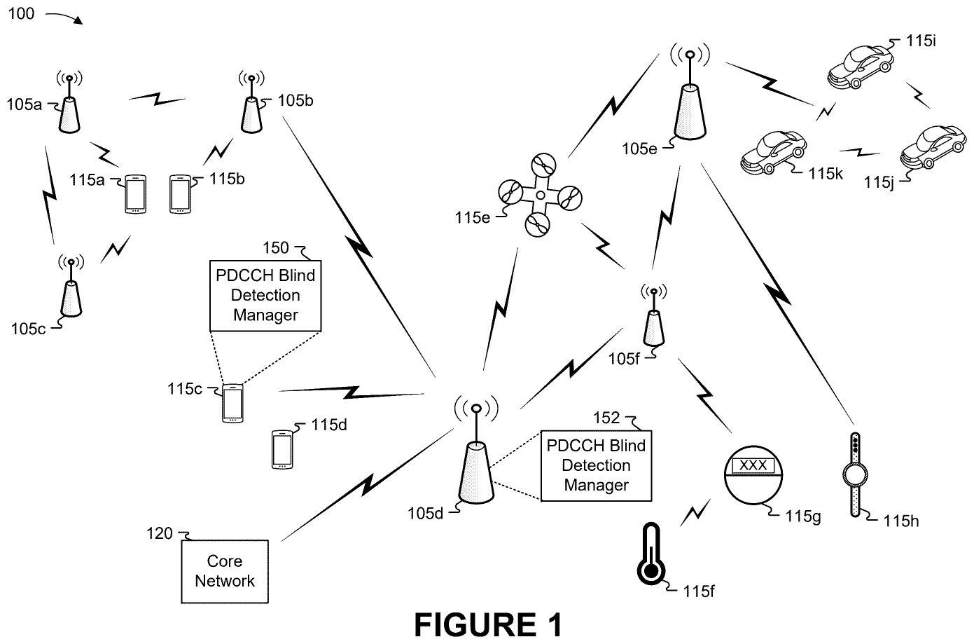

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

The wireless communication network 100 illustrated in FIG. 1 includes multiple network nodes 105, also referred to as network entities, and multiple user equipments (UEs) 115. A network node may be a station that communicates with UEs and may be referred to as a base station, an evolved node B (eNB), a next generation eNB (gNB), an access point, and the like. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 105 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 105 may consist of a single standalone base station or a single TRP that uses a full radio protocol stack to enable or facilitate communication between a UE 115 and a core network 120 of the wireless communication network 100.

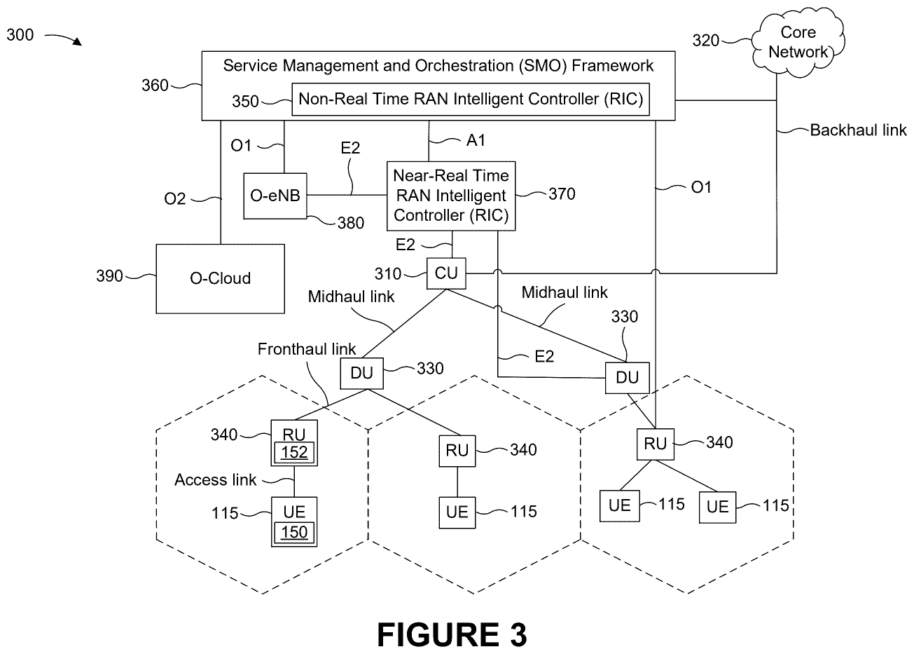

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture, as further described herein with reference to FIG. 3. In some deployments, disaggregated network nodes 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of a network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit DCI (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices, such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in a UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (COMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

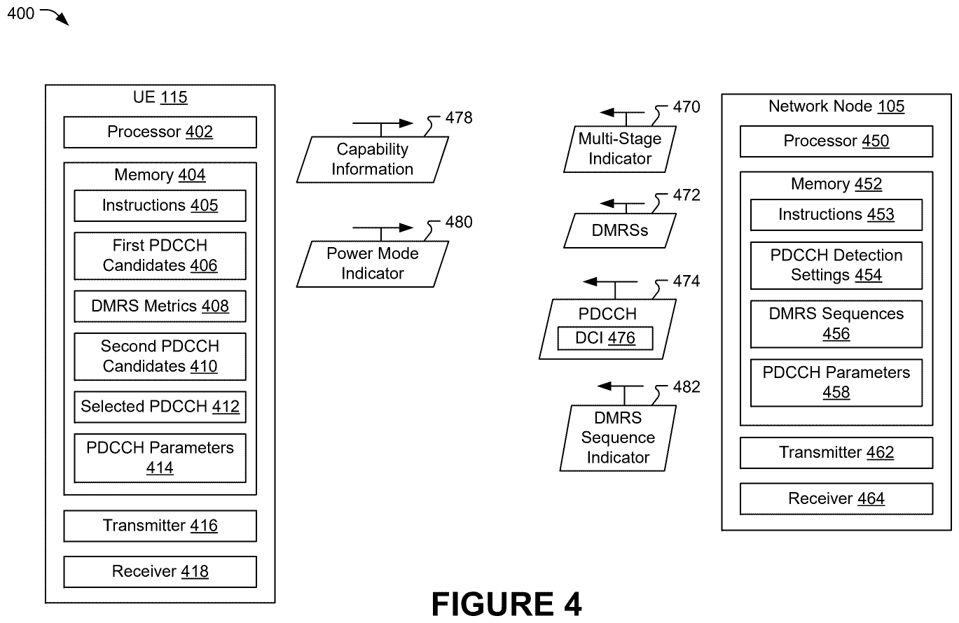

In some aspects, one or more of the network nodes 105 and one or more of the UEs may perform wireless communications that support a network configured multi-stage PDCCH blind detection procedure. For example, one or more of the UEs 115 (such as the UE 115c) may include a PDCCH blind detection manager 150 that manages operations at the UEs 115 that support a network configured multistage PDCCH blind detection procedure. The operations may include measuring DMRS signals associated with PDCCH candidates, performing blind detection operations on PDCCH candidates, and/or performing at least a portion of a PDCCH blind detection procedure in accordance with an indication associated with a DMRS sequence, as further described herein with reference to FIG. 4. As another example, one or more of the network nodes 105 (such as the network node 105d) may include a PDCCH blind detection manager 152 that manages operations that support a network configured multi-stage PDCCH blind detection procedure. The operations may include transmitting an indication of a two-stage PDCCH blind detection procedure, transmitting DCI via a PDCCH that is included in a set of PDCCH candidates of the two-stage PDCCH blind detection procedure, and/or transmitting an indication that an ID associated with initializing a DMRS sequence is UE-specific, as further described herein with reference to FIG. 4.

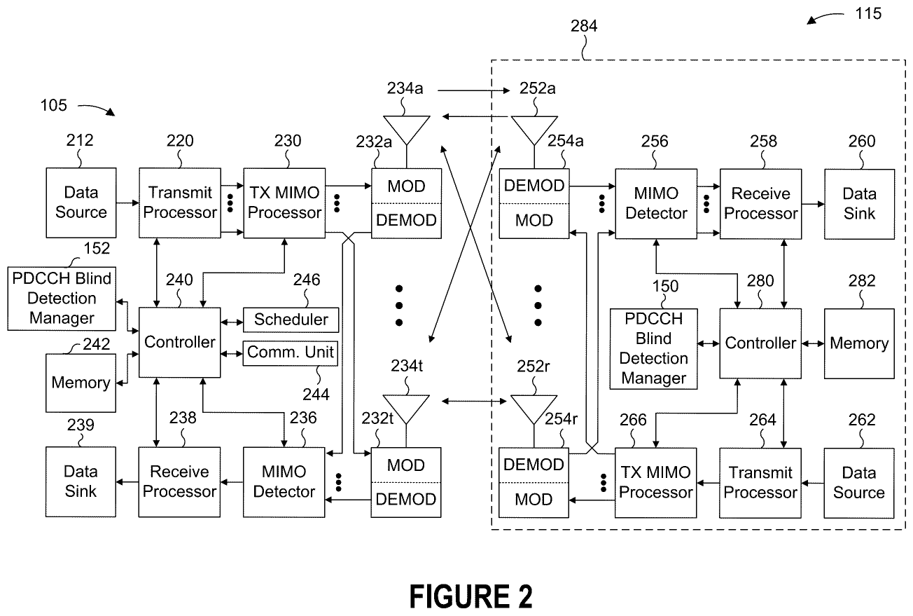

FIG. 2 is a block diagram illustrating examples of a network node 105 and a UE 115 in accordance with the present disclosure. The network node 105 and the UE 115 may be one of the network nodes 105 and one of the UEs 115 in FIG. 1. For a restricted association scenario, the network node 105 may be the small cell network node 105f in FIG. 1, and the UE 115 may be the UE 115c or 115d operating in a service area of the network node 105f, which in order to access the small cell network node 105f, would be included in a list of accessible UEs for the small cell network node 105f. Additionally, the network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by a TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by a MIMO detector 236 if applicable, and further processed by a receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

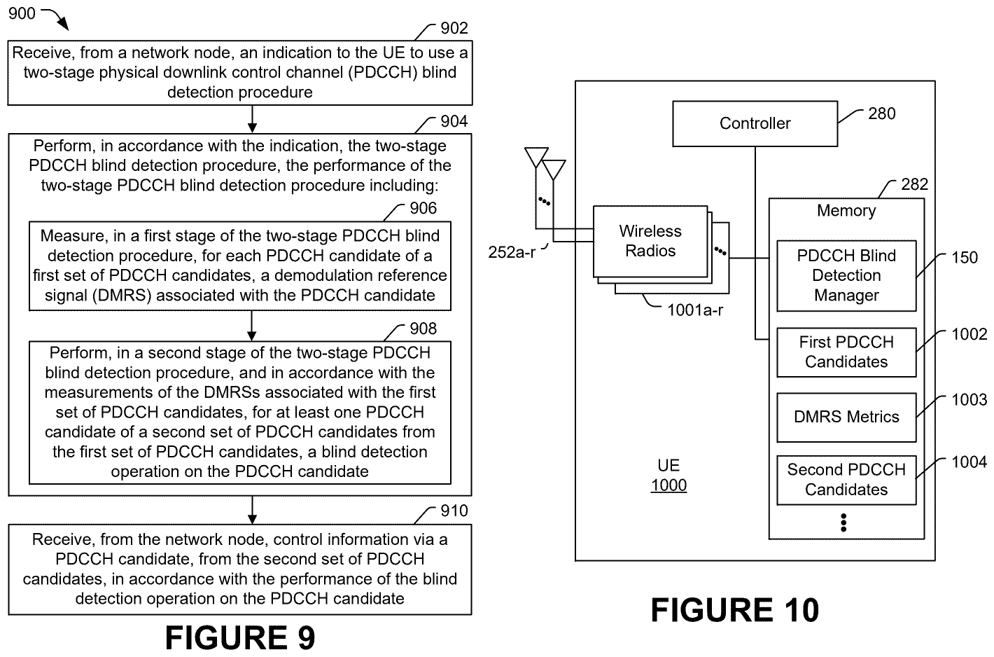

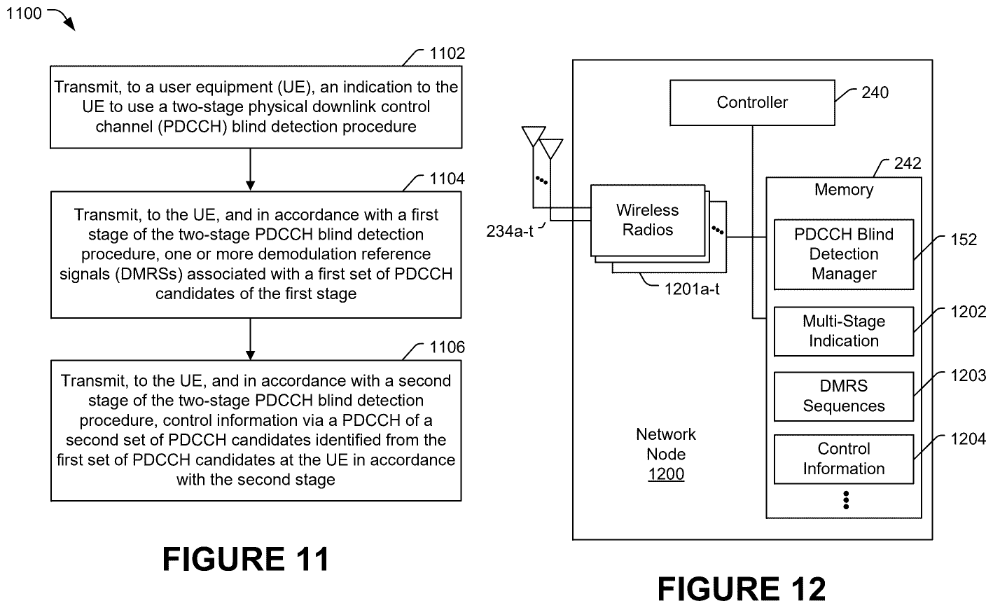

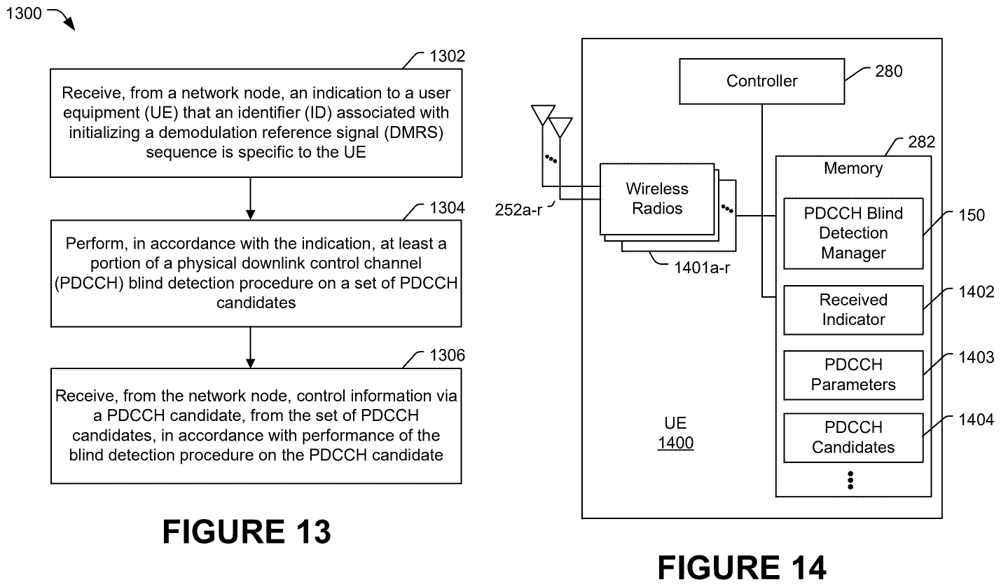

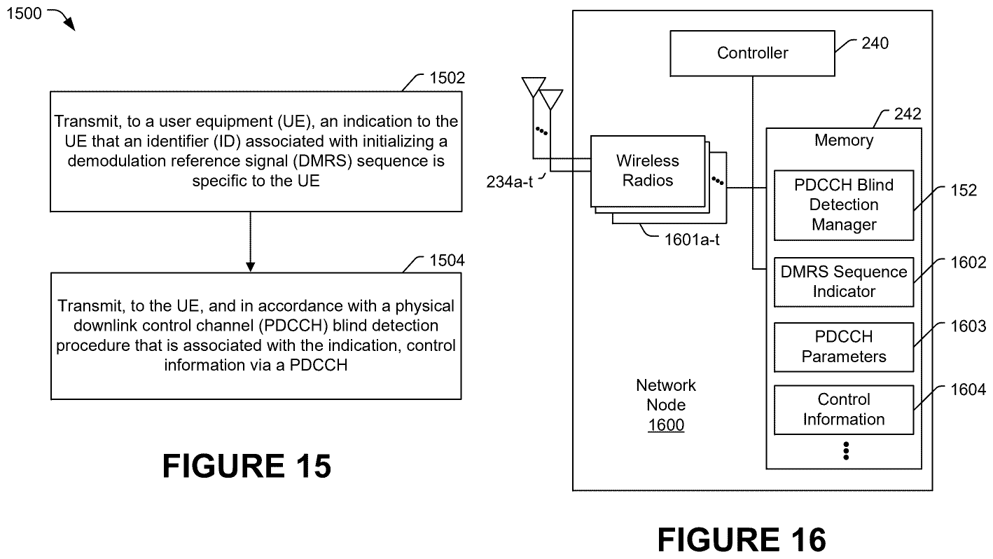

The controllers 240 and 280 may direct the operation at the network node 105 and the UE 115, respectively. The controller 240 (or other processors and modules at the network node 105) may perform or direct the execution of various processes for the techniques described herein, such as to perform or direct the execution illustrated in FIGS. 11 and 15, or other processes for the techniques described herein. Similarly, the controller 280 (or other processors and modules at the UE 115) may perform or direct the execution of various processes for the techniques described herein, such as to perform or direct the execution illustrated in FIGS. 9 and 13, or other processes for the techniques described herein. For example, the controller 240 and/or the controller 280 may perform or control operations that support a network configured multi-stage PDCCH blind detection procedure. Additionally, or alternatively, the UE 115 may include the PDCCH blind detection manager 150 and the network node 105 may include the PDCCH blind detection manager 152 that manage operations to support a network configured multi-stage PDCCH blind detection procedure, as further described herein. Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use a scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use a communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The UE 115, the CU 310, the DU 330, the RU 340, or any other component(s) of FIG. 3 may implement one or more techniques or perform one or more operations associated with network configured multi-stage PDCCH blind detection, as described in more detail elsewhere herein. For example, the UEs 115 may include the PDCCH blind detection manager 150 and the RU 340 may include the PDCCH blind detection manager 152, which may manage operations to support network configured multi-stage PDCCH blind detection. Although shown as being included in a single UE 115 in FIG. 3, any of the UEs 115 may include the PDCCH blind detection manager 150, and although shown as being included in a single RU 340 in FIG. 3, any of the RUs 340, the DUs 330, the CUS 310, the Non-RT RIC 350, the SMO Framework 360, the Near-RT RIC 370, or a combination thereof, may include the PDCCH blind detection manager 152. The PDCCH blind detection manager 150 may direct operations of, for example, the process 900 of FIG. 9, the process 1300 of FIG. 13, or other processes as described herein (alone or in conjunction with one or more other processors). Similarly, the PDCCH blind detection manager 152 may direct operations of, for example, the process 1100 of FIG. 11, the process 1500 of FIG. 15, or other processes as described herein (alone or in conjunction with one or more other processors). In some examples, the PDCCH blind detection manager 150 or the PDCCH blind detection manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the PDCCH blind detection manager 150 or one or more processors of the UE 115 may cause the one or more processors or the PDCCH blind detection manager 150 to perform the process 900 of FIG. 9, the process 1300 of FIG. 13, or other processes as described herein. As another example, the set of instructions, when executed (for example, directly, or after compiling, converting, or interpreting) by the PDCCH blind detection manager 152, one or more processors of the network node 105, the CU 310, the DU 330, the RU 340, the Non-RT RIC 350, the SMO Framework 360, or the Near-RT RIC 370, may cause the one or more processors or the PDCCH blind detection manager 152 to perform the process 1100 of FIG. 11, the process 1500 of FIG. 15, or other processes as described herein. In some examples, executing instructions may include running the instructions, converting the instructions, compiling the instructions, and/or interpreting the instructions, among other examples.

FIG. 4 is a block diagram illustrating an example wireless communication system 400 that supports a network configured multi-stage PDCCH blind detection procedure in accordance with the present disclosure. In some examples, the wireless communication system 400 may implement aspects of the wireless communication network 100. The wireless communication system 400 includes the UE 115 and the network node 105. Although one UE 115 and one network node 105 are illustrated, in some other implementations, the wireless communication system 400 may generally include multiple UEs 115, multiple network nodes 105, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 416 (hereinafter referred to collectively as “the transmitter 416”), and one or more receivers 418 (hereinafter referred to collectively as “the receiver 418”). Although referred to as a processor, the UE 115 may include one or more chips, system-on-chips (SoCs), chipsets, packages, or devices that individually or collectively constitute or include a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 402” or “the processor circuitry”).

One or more of the processors 402 may be individually or collectively configurable or configured to perform various functions or operations described herein. A group of processors collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 402 may be configured to execute instructions 405 stored in the memory 404 to perform the operations described herein. In some implementations, the processor 402 includes or corresponds the receive processor 258, the transmit processor 264, the controller 280, or a combination thereof, and the memory 404 includes or corresponds to the memory 282, described with reference to FIG. 2. In some implementations, the processor 402, the memory 404, the instructions 405, another component of the UE 115, or a combination thereof, may include or correspond to the PDCCH blind detection manager 150 of FIGS. 1-3 and/or may perform the operations associated with the PDCCH blind detection manager 150 to support a network configured multi-stage PDCCH blind detection procedure.

The memory 404 may be configured to store the instructions 405, a first set of one or more PDCCH candidates (hereinafter referred to collectively as “the first PDCCH candidates 406”), one or more DMRS metrics (hereinafter referred to collectively as “the DMRS metrics 408”), a second set of one or more PDCCH candidates (hereinafter referred to collectively as “the second PDCCH candidates 410”), a selected PDCCH 412, and one or more PDCCH parameters (hereinafter referred to collectively as “the PDCCH parameters 414”). The first PDCCH candidates 406 represent one or more candidate PDCCHs via which the network node 105 may transmit control information and for which the UE 115 may perform a PDCCH blind detection procedure, as further described herein. The DMRS metrics 408 are derived from measurements of one or more DMRSs that are transmitted by the network node 105 and which are used in some stages of some PDCCH blind detection procedures, as further described herein. The second PDCCH candidates 410 represent one or more candidate PDCCHs via which the network node 105 may transmit control information and for which the UE 115 may perform one or more stages of a multi-stage PDCCH blind detection procedure, as further described herein. In some implementations, the second PDCCH candidates 410 represent a subset (or an entirety) of the first PDCCH candidates 406. The selected PDCCH 412 represents a PDCCH selected by the UE 115 from either the first PDCCH candidates 406 or the second PDCCH candidates 410 during performance of a PDCCH blind detection procedure and is monitored to receive control information from the network node 105. The PDCCH parameters 414 include or indicate one or more parameters associated with the first PDCCH candidates 406, the second PDCCH candidates 410, a PDCCH blind detection procedure to be performed by the UE 115, or a combination thereof.

The transmitter 416 is configured to transmit reference signals, control information and data to one or more other devices, and the receiver 418 is configured to receive reference signals, synchronization signals, control information and data from one or more other devices. For example, the transmitter 416 may transmit signaling, control information and data to, and the receiver 418 may receive signaling, control information and data from, the network node 105. In some implementations, the transmitter 416 and the receiver 418 may be integrated in one or more transceivers. Additionally, or alternatively, the transmitter 416 or the receiver 418 may include or correspond to one or more components of the UE 115 described with reference to FIG. 2.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more transmitters 462 (hereinafter referred to collectively as “the transmitter 462”), and one or more receivers 464 (hereinafter referred to collectively as “the receiver 464”). Although referred to as a processor, the network node 105 may include one or more chips, SoCs, chipsets, packages, or devices that individually or collectively constitute or include a processing system. The processing system includes processor (or “processing”) circuitry in the form of one or multiple processors, microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 450” or “the processor circuitry”).

One or more of the processors 450 may be individually or collectively configurable or configured to perform various functions or operations described herein. A group of processors collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 450 may be configured to execute instructions 453 stored in the memory 452 to perform the operations described herein. In some implementations, the processor 450 includes or corresponds to the receive processor 238, the transmit processor 220, the controller 240, or a combination thereof, and the memory 452 includes or corresponds to the memory 242, described with reference to FIG. 2. In some implementations, the processor 450, the memory 452, the instructions 453, another component of the network node 105, or a combination thereof, may include or correspond to the PDCCH blind detection manager 152 of FIGS. 1-3 and/or may perform the operations associated with the PDCCH blind detection manager 152 to support network configured multi-stage PDCCH blind detection.

The memory 452 may be configured to store the instructions 453, one or more PDCCH detection settings 454 (hereinafter referred to collectively as “the PDCCH detection settings 454”), one or more DMRS initialization sequences 456 (hereinafter referred to collectively as “the DMRS sequences 456”), and one or more PDCCH parameters 458 (hereinafter referred to collectively as “the PDCCH parameters 458”). The PDCCH detection settings 454 represent information and/or parameters associated with PDCCH blind detection procedures associated with one or more UEs served by the network node 105, such as the UE 115. The DMRS sequences 456 include or indicate sequences used to initialize DMRSs that are transmitted by the network node 105 to one or more UEs, such as the UE 115. The DMRS sequences 456 may include or indicate UE-specific DMRS sequences, non-UE-specific DMRS sequences that are shared by multiple UEs, or both. The PDCCH parameters 458 include or indicate one or more parameters associated with PDCCH candidates associated with the UE 115, a PDCCH blind detection procedure to be performed by the UE 115, or a combination thereof. In some examples, the PDCCH parameters 458 stored at the network node 105 are the same as the PDCCH parameters 414 stored at the UE 115.

The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the UE 115. In some implementations, the transmitter 462 and the receiver 464 may be integrated in one or more transceivers. Additionally, or alternatively, the transmitter 462 or the receiver 464 may include or correspond to one or more components of network node 105 described with reference to FIG. 2.

In some implementations, the wireless communication system 400 is configured to implement a 5G NR network or a 6G network. For example, the wireless communication system 400 may include multiple 5G-capable UEs 115 (or 6G-capable UEs 115) and multiple 5G-capable network nodes 105 (or 6G-capable network nodes 105), such as UEs and network nodes configured to operate in accordance with a 5G NR network protocol, or a 6G network protocol, such as that defined by the 3GPP.

In some 5G wireless communication systems, the UE 115 is configured with one or more CORESETs by the network node 105. Each CORESET may be associated with one active transmission configuration indication (TCI) state, and as part of the CORESET configurations, resource blocks (RBs) of each CORESET in a frequency domain and a number of symbols of symbols of each CORESET are configured by RRC messaging from the network node 105. Each of the CORESET(s) may be associated with one or more search spaces (SS) sets, which are each a collection of PDCCH candidates that are to be blind detected by the UE 115 in certain monitoring occasions over a corresponding CORESET. For example, there can be up to ten SS sets in a BWP of a component carrier (CC). As part of a SS set configuration, the network node 105 may send RRC messaging to the UE 115 to configure one or more SS parameters. The SS parameters may include a SS set index, a SS set ID, an associated CORESET ID, or a combination thereof. Additionally, or alternatively, the SS parameters may include an indication of monitoring slots periodicity, monitoring slots offset, and monitoring symbols within monitoring slots. Additionally, or alternatively, the SS parameters may include an SS set type, one or more DCI formats to monitor, a number of PDCCH candidates for a given aggregation level, or a combination thereof. PDCCH candidates are defined as part of one or more SS set configurations by the network node 105. For example, a PDCCH candidate with a given aggregation level and a given candidate index may be defined in a given SS set.

To receive control information from the network node 105, the UE 115 may be configured to monitor PDCCH candidates in at least one SS set and perform channel estimation and then blind detection operations on the PDCCH candidates. The blind detection operation may include performing CRC decoding on the PDCCH candidates using an ID associated with the UE 115. If one or more of the PDCCH candidates pass the CRC decoding, the one or more PDCCH candidates are identified as PDCCHs that contain DCI for the UE 115. The ID may be a type of radio network temporary identifier (RNTI), examples of which include a cell radio network temporary identifier (C-RNTI), a temporary cell radio network temporary identifier (TC-RNTI), a configured scheduling radio network temporary identifier (CS-RNTI), a system information radio network temporary identifier (SI-RNTI), a paging radio network temporary identifier (P-RNTI), a random access radio network temporary identifier (RA-RNTI), or another type of RNTI. As an example of CRC-encoded DCI that may be blind detected by the UE 115, the network node 105 may scramble the CRC of DCI in accordance with a C-RNTI for a unicast PDCCH to an RRC-connected UE.

Performing the channel estimation and the CRC decoding on each of a set of PDCCH candidates associated with configured CORESETs may be referred to as performing a single-stage PDCCH blind detection procedure. There can be multiple search spaces for the UE 115 to monitor in one time slot, and to limit or prevent over dedication of resources to blind detection, a PDCCH blind detection limit and a non-overlapped CCE limit may be defined. The PDCCH blind detection limit represents a maximum number of blind detection operations to be performed by UEs and the non-overlapped CCE limit represents a maximum number of CCEs covered by the blind detection operations. The PDCCH blind detection limit, the non-overlapped CCE limit, or both, may be preprogrammed at the UE 115 or indicated in signaling received from the network node 105. In some implementations, the PDCCH blind detection limit, the non-overlapped CCE limit, or both, are defined in a wireless communications standard, such as a 3GPP wireless communications standard. Thus, a number of blind detection operations, also referred to as blind decode operations, and a number of covered non-overlapping CCEs are predefined for the single-stage PDCCH blind detection procedure. Because the blind detection operations can use significant processing resources and incur significant power consumption at the UE 115, aspects described herein support a multi-stage PDCCH blind detection procedure that reduces the processing resource usage and power consumption of the single-stage PDCCH blind detection procedure or that focuses the blind detection operations on PDCCH candidates that are more likely to contain DCI for the UE 115.

During operation of the wireless communication system 400, the network node 105 configures the UE 115 to perform one of multiple PDCCH blind detection procedures. The multiple PDCCH blind detection procedures include a single-stage PDCCH blind detection procedure and a multi-stage PDCCH blind detection procedure. Examples described herein are in the context of a two-stage PDCCH blind detection procedure that includes a first stage for detecting, based on measuring DMRSs, one or multiple PDCCH candidates among a larger set of preliminary PDCCH candidates and a second stage for performing blind detection operations, including CRC decoding/descrambling using a configurable ID, on the selected PDCCH candidates. Although described as a two-stage procedure, in other implementations, the multi-stage PDCCH blind detection procedure may include more than two stages, with one or more stages of the multi-stage procedure including the operations of the first stage of the two-stage procedure and another one or more stages of the multi-stage procedure including the operations of the second stage of the two-stage procedure.

To configure the UE 115 to perform the two-stage PDCCH blind detection procedure, the network node 105 transmits an indication to the UE 115 to use the two-stage PDCCH blind detection procedure. For example, the network node 105 may send a multi-stage indicator 470 to the UE 115 to configure the UE 115 for performance of the two-stage PDCCH blind detection procedure. The multi-stage indicator 470 may include or correspond to a message or a portion of a message, such as a field or a set of one or more bits, that indicate which type of PDCCH blind detection procedure is to be performed by the UE 115. For example, the multi-stage indicator 470 having a first particular value, such as ‘1’, may indicate that the UE 115 is to perform the two-stage PDCCH blind detection procedure. As another example, the multi-stage indicator 470 having a second particular value, such as ‘0’, may indicate that the UE 115 is to perform the single-stage PDCCH detection procedure. Alternatively, the multi-stage indicator 470 may be a first indicator that indicates that the UE 115 is to perform the two-stage PDCCH blind detection procedure, and a different indicator (a “single-stage” indicator) may indicate that that UE 115 is to perform the single-stage PDCCH blind detection procedure.

In some examples, the network node 105 may store the PDCCH detection settings 454 that track the types of PDCCH blind detection procedures being performed by one or more UEs that are served by the network node 105. Additionally, the network node 105 may generate or update the setting of the PDCCH detection settings 454 that corresponds to the UE 115 in accordance with the transmission of the multi-stage indicator 470 to track the type of PDCCH blind detection procedure being performed by the UE 115.

The network node 105 may communicate the multi-stage indicator 470 in a variety of messaging or signaling. As an example, the multi-stage indicator 470 may include or correspond to, or be included within, a message sent by the network node 105 during an initialization process associated with establishment of a communication link between the UE 115 and the network node 105. In this example, an initialization message may include the multi-stage indicator 470, initial values of one or more parameters, one or more other indicators, initialization information, or a combination thereof. Such an initialization message may be transmitted by the network node 105 to being an initialization process for establishment of the communication link, or the message may be sent in response to a message received from the UE 115. In such an example, activation or deactivation of the two-stage PDCCH blind detection procedure is static or semi-static. As another example, the multi-stage indicator 470 may include or correspond to, or be included within, a medium access control (MAC) control element (MAC-CE) sent by the network node 105 or DCI sent by the network node 105. In this example, the MAC-CE or the DCI may include the multi-stage indicator 470, and the MAC-CE or DCI may be sent by the network node 105 at various times while the UE 115 is wireless connected to the network node 105. In such an example, activation or deactivation of the two-stage PDCCH blind detection procedure can be dynamic, such as based on a determination or trigger condition at the network node 105.

In some implementations, the network node 105 transmits the multi-stage indicator 470 in accordance with UE capability information for multi-stage PDCCH blind detection. For example, the UE 115 may transmit capability information 478 to the network node 105 and, based on the capability information 478, the network node 105 may transmit the multi-stage indicator 470. The capability information 478 may indicate a blind detection capability of the UE 115, also referred to as a PDCCH blind detection capability of the UE 115. The blind detection capability indicates whether the UE 115 is capable of performing the two-stage PDCCH blind detection procedure (or other multi-stage PDCCH blind detection procedures) or whether the UE 115 is only capable of performing the single-stage PDCCH blind detection procedure. If the capability information 478 indicates that the UE 115 is capable of performing the two-stage PDCCH blind detection procedure, the network node 105 may transmit, in accordance with receiving the capability information 478, the multi-stage indicator 470 to indicate that the UE 115 is to perform the two-stage PDCCH blind detection procedure. Alternatively, if the capability information 478 indicates that the UE 115 is not capable of performing the two-stage PDCCH blind detection procedure, i.e., that the UE 115 is only capable of performing the single-stage PDCCH blind detection procedure, the network node 105 may transmit, in accordance with receiving the capability information 478, an indication of the single-stage PDCCH blind detection procedure.

Additionally, or alternatively, the network node 105 may transmit the multi-stage indicator 470 in accordance with a low power mode of operation at the UE 115. For example, the UE 115 may, as part of transitioning to a low power mode (a “power saving” mode) such as an idle mode or a sleep mode, transmit a power mode indicator 480 to the network node 105. The power mode indicator 480 may indicate a power mode in which the UE 115 is operating, such as a low power operating mode or a normal/higher power operating mode. The power mode indicator 480 may be included in or correspond to a distinct message or signaling, or the power mode indicator 480 may be included in another message or signaling, such as a request to enter a low power mode or UCI. The network node 105 may transmit the multi-stage indicator 470 in accordance with the power mode indicator 480. For example, if the power mode indicator 480 indicates that the UE 115 is in the low power mode, the network node 105 may transmit the multi-stage indicator 470 to the UE 115 in accordance with receiving the power mode indicator 480, such as in implementations in which the two-stage PDCCH blind detection procedure reduces power consumption as compared to the single-stage PDCCH blind detection procedure. As another example, if the power mode indicator 480 indicates that the UE 115 is not in the low power mode, e.g., is in a standard or higher power mode, the network node 105 may send an indication of the single-stage PDCCH blind detection procedure to the UE 115 in accordance with receiving the power mode indicator 480. The activation or deactivation of two-stage PDCCH blind detection procedure in accordance with the power mode indicator 480 may be static or semi-static, such as if the UE 115 transmits the power mode indicator 480 during an initialization process for a communication link with the network node 105 or periodically.

Alternatively, the activation or deactivation of two-stage PDCCH blind detection procedure in accordance with the power mode indicator 480 may be dynamic, such as if the UE 115 transmits the power mode indicator 480 in an uplink MAC-CE, a PUCCH, UCI within a PUSCH, or a combination thereof. In some implementations in which the activation of the two-stage PDCCH blind detection procedure is dynamic, a predefined processing time may be applied between receipt of the power mode indicator 480 at the network node 105 and activation/deactivation of the two-stage PDCCH blind detection procedure via transmission of the multi-stage indicator 470. For example, the network node 105 may transmit the multi-stage indicator 470 after expiration of a time period that starts when the power mode indicator 480 is received by the network node 105. The time period may have a duration of a few milliseconds, such as 1-5 ms, or another duration. In some implementations, the duration of the processing time or a requested starting time (of activation or deactivation of the two-stage PDCCH blind detection procedure) may be included in the power mode indicator 480.

The UE 115 receives the multi-stage indicator 470 and selects a PDCCH blind detection procedure to be performed in accordance with the multi-stage indicator 470. For example, the UE 115 may perform a two-stage PDCCH blind detection procedure in accordance with the multi-stage indicator 470 indicating to perform the two-stage procedure. As another example, if the multi-stage indicator 470 (or a different indicator) indicates to perform a single-stage PDCCH blind detection procedure, the UE 115 may perform the single-stage PDCCH blind detection procedure in accordance with the multi-stage indicator 470.

In some implementations, the UE 115 selects which PDCCH blind detection procedure to perform in accordance with one or more of the PDCCH parameters 414. For example, if one of the PDCCH parameters 414 has a first particular value, the UE 115 may perform the two-stage PDCCH blind detection procedure. Alternatively, if the same one of the PDCCH parameters 414 has a second particular value, the UE 115 may perform the single-stage PDCCH blind detection procedure. The PDCCH parameters 414 which may influence the UE 115 to perform a particular PDCCH blind detection procedure include a subcarrier spacing associated with the first PDCCH candidates 406, a frequency range associated with the first PDCCH candidates 406, a frequency band associated with the first PDCCH candidates 406, a total number of actively monitored components associated with the first PDCCH candidates 406, other parameters, or a combination thereof. As an illustrative example, if the subcarrier spacing associated with the first PDCCH candidates 406 satisfies a threshold, the UE 115 may perform the two-stage PDCCH blind detection procedure. In other implementations, if described herein, satisfying a threshold may include being greater than the threshold, being less than the threshold, or being less than or equal to the threshold. Although described as the UE 115 determining which PDCCH blind detection procedure to perform in accordance with one or more of the PDCCH parameters 414, in other implementations, the network node 105 may determine whether to send the multi-stage indicator 470/configure the UE 115 to perform the two-stage PDCCH blind detection procedure in accordance with one or more of the PDCCH parameters 458, in the same manner as described for the UE 115 and the PDCCH parameters 414.

The two-stage PDCCH blind detection procedure includes operations performed during a first stage of the procedure followed by operations performed during a second stage of the procedure. During the first stage, the UE 115 may measure, for each PDCCH candidate of the first PDCCH candidates 406, a DMRS associated with the PDCCH candidate. For example, the network node 105 may transmit one or more DMRSs 472 across one or more of the first PDCCH candidates 406, and the UE 115 may perform one or more signal measurements, channel estimations, or a combination thereof, on the DMRSs 472 to generate signal measurements. The measurements may include signal power or strength measurements, interference or noise measurements, amplitude measurements, frequency measurements, phase measurements, other measurements, or a combination thereof, and the UE 115 may store the signal measurements and/or metrics derived from the signal measurements as the DMRS metrics 408.

The first PDCCH candidates 406 may be indicated by one or more CORESETs or signaled by the network node 105, and the UE 115 may identify the first PDCCH candidates 406 in accordance with parameters associated with the CORESET(s) or in RRC signaling from the network node 105. In some implementations, the first PDCCH candidates 406 may be constrained by one or more limits, alternatively referred to as a second set of parameters. For example, a quantity of PDCCH candidates in the first PDCCH candidates 406 may be required to be less than or equal to a PDCCH blind detection limit. As another example, a total number of non-overlapped CCE elements covered by the first PDCCH candidates 406 may be required to be less than a non-overlapped CCE limit.

The PDCCH blind detection limit, the non-overlapped CCE limit, or both, may be specified in a wireless communications standard and preprogrammed at the UE 115 or received from signaling by the network node 105. In some implementations, these limits may apply to the first PDCCH candidates 406 if the single-stage PDCCH blind detection procedure is being performed, and these limits may apply to the second PDCCH candidates 410 if the two-stage PDCCH blind detection procedure is being performed. Alternatively, the CORESETs or RRC signaling from the network node 105 may indicate a first set of limits associated with the first PDCCH candidates 406 and a second set of limits associated with the second PDCCH candidates 410. Alternatively, the PDCCH blind detection limit, the non-overlapped CCE limit, or both, may apply to the first PDCCH candidates 406 regardless of what type of PDCCH blind detection procedure is being performed. The UE 115 may identify the first PDCCH candidates 406 further in accordance with any limits, such that one or more blind detection conditions are obeyed by all UEs communicating with the network node 105.

In accordance with performing measurements of the DMRSs 472, the UE 115 may generate or derive the DMRS metrics 408 from the resultant signal measurements. For example, for each PDCCH candidate of the first PDCCH candidates 406, the UE 115 may generate a corresponding DMRS metric of the DMRS metrics 408 that is associated with the PDCCH candidate. As such, the DMRS metrics 408 may represent the signal measurements, or values derived therefrom, that are generated from measuring the DMRSs 472. The DMRS metrics 408 may include various metrics calculated in accordance with measurement(s) of a DMRS, such as a DMRS reference signal receive power (RSRP), an estimated DMRS signal to interference and noise ratio (SINR), a metric calculated or derived from the DMRS RSRP, a metric calculated or derived from the DMRS SINR, an estimated block error rate (BLER) which may also be referred to as a “hypothetical BLER”, other metrics, or a combination thereof. For example, the DMRS metrics 408 may include an estimated SINR of the DMRSs 472 that the UE 115 calculates based on a cosine similarity between the received signal on one or more DMRS resource elements (REs) and an expected noiseless DMRS on the same DMRS REs according to an associated DMRS sequence. Alternatively, a metric such as a hypothetical BLER or a “candidate presence probability” that is calculated or derived from the estimated SINR may be stored as the DMRS metrics 408.

The UE 115 may select one or more PDCCH candidates from the first PDCCH candidates 406 for inclusion in the second PDCCH candidates 410 in accordance with the DMRS metrics 408 to filter one or more PDCCH candidates prior to performing blind detection operations. The selection may occur after the DMRS metrics 408 are generated for each of the first PDCCH candidates 406, or after at least one or more of the DMRSs 472 are measured in the case of parallel measurement and generation of the DMRS metrics 408. In some implementations, PDCCH candidates may be included in the second PDCCH candidates 410 if an associated DMRS metric of the DMRS metrics 408 satisfies a threshold. For example, if the DMRS metrics 408 include a hypothetical BLER that is determined from a DMRS RSRP or an estimated DMRS SINR, the UE 115 may select a subset of the first PDCCH candidates 406 for inclusion in the second PDCCH candidates 410, with each PDCCH candidate of the subset being associated with a hypothetical BLER that satisfies a threshold BLER. Additionally, or alternatively, a threshold number of PDCCH candidates associated with the largest (or smallest) DMRS metrics 408 may be included in the second PDCCH candidates 410. For example, if the threshold number is twenty, the twenty PDCCH candidates of the first PDCCH candidates 406 that are associated with the twenty largest (or smallest) values of the DMRS metrics 408 may be selected by the UE 115 for inclusion in the second PDCCH candidates 410. As such, the first PDCCH candidates 406 may represent a PDCCH search space with multiple preliminary PDCCH candidates, where only some of the preliminary PDCCH candidates that represent a filtered set are elected for blind detection based on associated ones of the DMRS metrics 408, such as candidate presence probabilities or hypothetical BLERs that are estimated based on DMRS RSRPs, DMRS SINRs, or other signal measurements from the DMRSs 472.

In some implementations, the UE 115 may stop the two-stage PDCCH blind detection procedure after the first stage, and omit performance of the second stage, if none of the DMRS metrics 408 associated with the first PDCCH candidates 406 satisfy a certain DMRS metric threshold, such as a threshold candidate presence probability or a threshold hypothetical BLER. Stopping the two-stage PDCCH blind detection procedure may cause the UE 115 to wait for a period of time before initiating another iteration of the procedure or to transition to another type of PDCCH blind detection procedure. Alternatively, the UE 115 may perform an error recovery procedure or provide an indication to the network node 105 upon stopping the PDCCH blind detection procedure after performance of the first stage. In some such implementations, the DMRS metric threshold may be configured by the network node 105, such as via appropriate signaling or messaging. In some other implementations, the DMRS metric threshold may be predefined, such as a value specified in a wireless communications standard, and preprogrammed at the UE 115. In some other implementations, the UE 115 may select or determine the DMRS metric threshold according to UE implementation.

In some implementations, the second PDCCH candidates 410 may be constrained by one or more limits, alternatively referred to as a second set of parameters. For example, a quantity of PDCCH candidates in the second PDCCH candidates 410 may be required to be less than or equal to a PDCCH blind detection limit. As another example, a total number of non-overlapped CCE elements covered by the second PDCCH candidates 410 may be required to be less than or equal to a non-overlapped CCE limit. The PDCCH blind detection limit, the non-overlapped CCE limit, or both, may be specified in a wireless communications standard and preprogrammed at the UE 115 or received from signaling by the network node 105, as described above. In some implementations, these limits may only apply to the second PDCCH candidates 410, and not the first PDCCH candidates 406, if the two-stage PDCCH blind detection procedure is being performed. Alternatively, the CORESETs or RRC signaling from the network node 105 may indicate a first set of limits associated with the first PDCCH candidates 406 and a second set of limits associated with the second PDCCH candidates 410. In this situation, the PDCCH blind detection limit and/or the non-overlapped CCE limit associated with the second PDCCH candidates 410 may be more stringent than the PDCCH blind detection limit and/or the non-overlapped CCE limit associated with the first PDCCH candidates 406.

If the UE 115 proceeds to the second stage of the two-stage PDCCH blind detection procedure, the UE 115 may perform one or more blind detection operations to attempt to detect and decode DCI contained therein. For example, during the second stage the UE 115 may perform, for at least one PDCCH candidate of the second PDCCH candidates 410, a blind detection operation on the PDCCH candidate. The blind detection operations may be said to be performed in accordance with the DMRS metrics 408, as the second PDCCH candidates 410 are identified or selected using the DMRS metrics 408. The blind detection operations may include generating a channel estimation and attempting to decode the CRC of a hypothetical DCI in accordance with an ID associated with the UE 115, such as an RNTI. If a CRC decoding is successful, the UE 115 may identify the PDCCH candidate as the selected PDCCH 412 that represents a PDCCH 474 that is assigned to the UE 115 by the network node 105. The UE 115 may monitor the selected PDCCH 412/the PDCCH 474 to receive and decode control information, such as DCI 476, from the network node 105. In some implementations, the UE 115 may terminate the PDCCH blind detection procedure in response to a successful blind detection operation on a PDCCH candidate. Alternatively, the UE 115 may continue performing the second stage of the PDCCH blind detection procedure until a threshold number of completed blind detection operations occur or until blind detection is attempted on each of the second PDCCH candidates 410.

As a result of successful performance of the two-stage PDCCH blind detection procedure, the UE 115 identifies the selected PDCCH 412. Unless a false positive occurs, the selected PDCCH 412 corresponds to the PDCCH 474 that is assigned to the UE 115 by the network node 105. The network node 105 sends the DCI 476 to the UE 115 within the PDCCH 474, and the UE 115 may receive and decode the DCI 476 in accordance with the ID associated with the UE 115. If the DCI 476 is the first control information sent to the UE 115, the DCI 476 may indicate resources associated with a UE-specific PDCCH for the UE 115. Alternatively, if the PDCCH 474 is a UE-specific PDCCH, the DCI 476 may indicate resources associated with a PDSCH for the UE 115. The UE 115 may monitor the channel(s) indicated by the DCI 476 to receive additional DCI or downlink (DL) data from the network node 105.

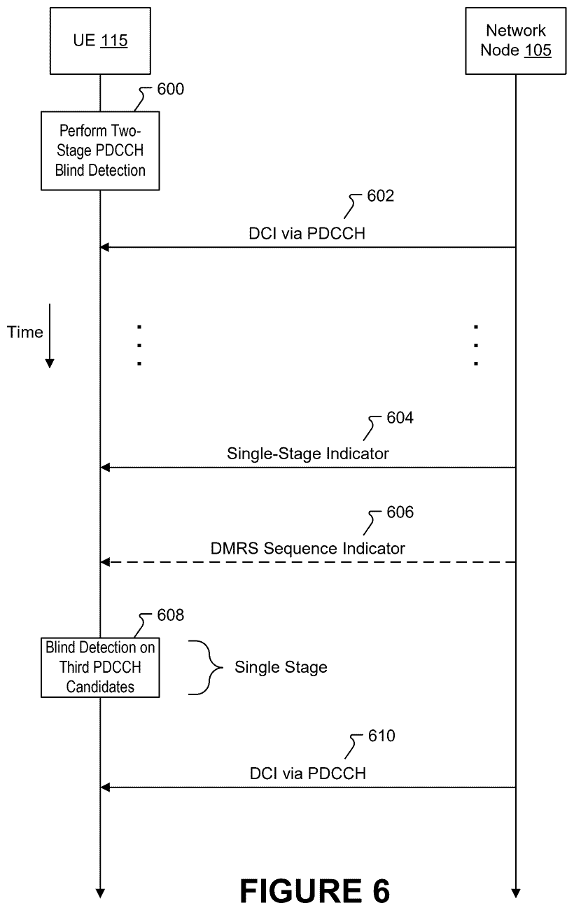

In some implementations, the activation or deactivation of the two-stage PDCCH blind detection procedure is static and only configured during an initialization process. In other implementations, the activation or deactivation can be semi-static or dynamic, and thus the UE 115 may transition from performing one type of PDCCH blind detection procedure to performing another type of PDCCH blind detection procedure. For example, at a later time after the UE 115 has received and processed the DCI 476, the network node 105 may transmit a second indicator that indicates the UE 115 is to perform the single-stage PDCCH blind detection procedure. In response to receiving the second indicator, the UE 115 may transition to performing the single-stage PDCCH blind detection procedure. The single-stage PDCCH blind detection procedure may include only the operations of the second stage of the two-stage procedure described above, except that the blind detection operations are performed on the first PDCCH candidates 406 (and no measurements of the DMRSs 472 are performed nor are the second PDCCH candidates identified). An example of transitioning from performing the two-stage PDCCH blind detection procedure to performing the single-stage blind detection procedure is further described herein with reference to FIG. 6.

In some implementations, the UE 115 is configured with a particular DMRS sequence for use in performing the first stage of the two-stage PDCCH blind detection procedure, such as for measuring the DMRSs 472. The DMRS sequence corresponds to a sequence used to initialize one or more of the DMRSs 472 by the network node 105, which can enable better detection and estimation or measurement of the DMRSs 472 by the UE 115. For example, to have good performance of DMRS measurements, an estimate of DMRS SINR may be performed by estimating the cosine similarity of the signal received on DMRS REs with the signal associated with the DMRS sequence. However, if the DMRS sequence is not UE-specific to the UE 115, the UE 115 may generate high quality DMRS measurements for PDCCH candidates that contain DCI for other UEs because the same DMRS sequence that is associated with the UE 115 is used to generate the DMRSs associated with these PDCCH candidates, resulting in excess blind detection operations and increased false positive detections.

In some typical 5G wireless communication systems, a DMRS is mapped on all resource element groups (REGs) on all the OFDM symbols of a given PDCCH candidate. The DMRS density is the same on all REGs and DMRS positions are evenly distributed within each REG. Additionally, a UE may be associated with a configurable ID for PDCCH DMRS, at least for the initialization of a DMRS sequence/scrambling. For example, for a CORESET that is configured by PBCH, a physical cell ID can be used for DMRS sequence initialization. As another example, for a CORESET that is configured by remaining minimum system information (RMSI), a configurable ID may be communicated to the UE via RMSI or a default of a physical cell ID may be used. As another example, for a CORESET that is configured by UE-specific RRC signaling, a UE may be configured with a configurable ID, N_{ID}⁽ⁿ^{_{SCID}}⁾, which can be a 16-bit scrambling ID with a default value of a physical cell ID combined with multiple predefined bits, such as a 6-bit value such as ‘000000’, as a non-limiting example. A DMRS and an associated PDCCH, after coding, are scrambled in accordance with the same sequence, which may be a length-31 Gold sequence. Additionally, a DMRS sequence associated with a PDCCH may be obtained according to a reference point in the frequency domain. For example, the reference point may be physical resource block (PRB) 0 of common PRB indexing for a UE-specific CORESET or PRB 0 of the initial active DL BWP for a CORESET configured by PBCH or RMSI. A QCL configuration or indication may be on a per-CORESET basis. As such, a DMRS sequence that is common to multiple UEs, e.g., that has a group common DMRS sequence ID or a non-UE-specific DMRS sequence ID, may result in a PDCCH that is decodable by multiple UEs. However, such a PDCCH contains DCI for a single UE, resulting in false-positive PDCCH blind detections at other UEs that are associated with the same DMRS sequence ID.

In some implementations, to reduce or prevent false positive PDCCH blind detections, the UE 115 performs a PDCCH blind detection procedure in accordance with a DMRS sequence indicator 482. The DMRS sequence indicator 482 may represent an indication whether a configurable ID associated with initializing a DMRS sequence is specific to the UE 115. For example, the DMRS sequence indicator 482 may indicate whether the configurable ID associated with the UE 115 is only used by the UE 115 and thus is specific to the UE 115, or whether the configurable ID associated with the UE 115 is a non-UE-specific ID that is shared with other UEs. In aspects, the network node 105 may initialize one or more of the DMRS sequences 456 in accordance with the configurable ID associated with the UE 115, and the network node 105 may use the DMRS sequences 456 to generate the DMRSs 472 that are sent to the UE 115. The network node 105 may transmit the DMRS sequence indicator 482 to the UE 115 to indicate whether the configurable ID associated with the UE 115 and used during a process of generating the DMRSs 472 is UE-specific, i.e., is specific to the UE 115 and not shared by other UEs. A configurable ID is UE-specific if the network node 105 determines or selects a particular ID, and the network node 105 assigns the particular ID to a single UE and not to other UEs. In response to receiving the DMRS sequence indicator 482, the UE 115 may perform at least a portion of a PDCCH blind detection procedure in accordance with the DMRS sequence indicator 482, as further described herein. In the example shown in FIG. 4, the DMRS sequence indicator 482 and the multi-stage indicator 470 are distinct indicators that are sent by the network node 105. In some other implementations, the multi-stage indicator 470 and the DMRS sequence indicator 482 may be replaced by a single indicator. For example, because an indication of whether the configurable ID is UE-specific can serve as an indication whether the UE 115 is to perform the two-stage PDCCH blind detection procedure, the DMRS sequence indicator 482 may serve as the multi-stage indicator 470.

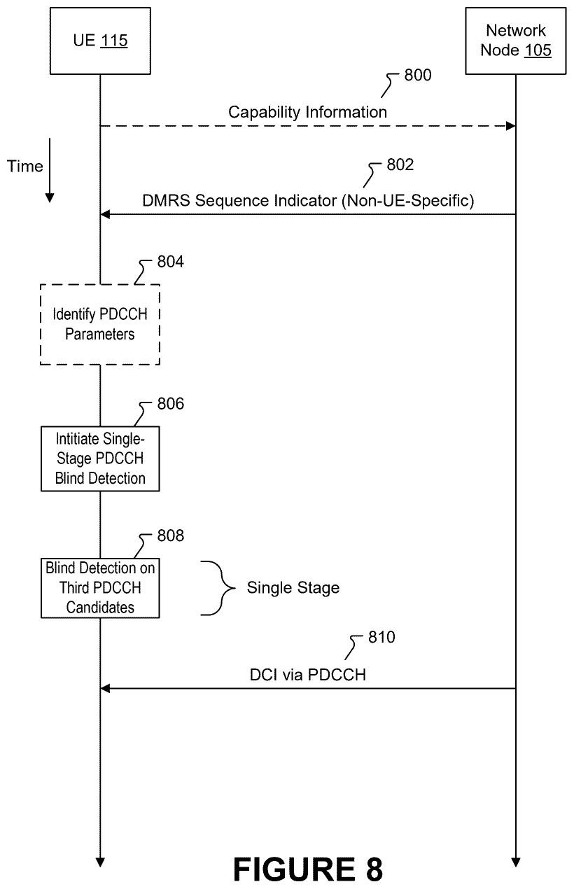

The DMRS sequence indicator 482 may include or correspond to, or be included in, various types of messages or signaling. In some implementations, the DMRS sequence indicator 482 is included in a configuration message associated with a UE-specific CORESET for the UE 115. For example, the DMRS sequence indicator 482 may be a flag in the configuration of the UE-specific CORESET. The UE 115 may identify the DMRS sequence indicator 482 in the configuration message and perform one or more operations a PDCCH blind detection procedure in accordance with whether the DMRS sequence indicator 482 indicates that the ID is UE-specific or non-UE-specific. In some such implementations, the indication provided by the DMRS sequence indicator 482 is semi-static, and the network node 105 may change the DMRS sequence indicator 482 by sending a new configuration message to the UE 115. Alternatively, the indication provided by the DMRS sequence indicator 482 may be dynamic. In some implementations in which the indication is dynamic, the DMRS sequence indicator 482 is included in a MAC-CE or DCI. For example, the network node 105 may transmit a MAC-CE or DCI that includes the DMRS sequence indicator 482, and the UE 115 may identify the DMRS sequence indicator in the MAC-CE or the DCI and perform one or more operations of a PDCCH blind detection procedure in accordance with whether the DMRS sequence indicator 482 indicates that the ID is UE-specific or non-UE-specific. In some such examples, the network node 105 may dynamically change whether the configurable ID is UE-specific by sending another DMRS sequence indicator to the UE 115 to cause the UE 115 to change at least some performance of a PDCCH blind detection procedure, as further described herein with reference to FIG. 8.

In some implementations, the network node 105 transmits the DMRS sequence indicator 482 in accordance with a UE capability for multi-stage PDCCH blind detection. For example, the UE 115 may transmit the capability information 478 to the network node 105 and, based on the capability information 478, the network node 105 may transmit the DMRS sequence indicator 482. As described above, the capability information 478 may indicate whether the UE 115 is capable of performing the two-stage PDCCH blind detection procedure (or other multi-stage PDCCH blind detection procedures) or whether the UE 115 is only capable of performing the single-stage PDCCH blind detection procedure, one of which is performed if the configurable ID associated with the UE 115 is UE-specific. If the capability information 478 indicates that the UE 115 is capable of performing the two-stage PDCCH blind detection procedure, the network node 105 may transmit the DMRS sequence indicator 482 having a first value to indicate that the configurable ID associated with the UE 115 is UE-specific, and thus that the UE 115 is to perform the two-stage PDCCH blind detection procedure, in accordance with receiving the capability information 478. Alternatively, if the capability information 478 indicates that the UE 115 is not capable of performing the two-stage PDCCH blind detection procedure, i.e., that the UE 115 is only capable of performing the single-stage PDCCH blind detection procedure, the network node 105 may transmit the DMRS sequence indicator 482 having a second value to indicate that the configurable ID is not UE-specific, and thus that the UE 115 is to perform the single-stage PDCCH blind detection procedure, in accordance with receiving the capability information 478.

In some implementations, the network node 105 determines whether the configurable ID associated with the UE 115 is to be UE-specific or not UE-specific in accordance with one or more of the PDCCH parameters 458. For example, if one of the PDCCH parameters 458 has a first particular value, the network node 105 may determine that the configurable ID is to be UE-specific and thus cause the DMRS sequence indicator 482 to have a first value indicating that the configurable ID is UE-specific. Alternatively, if the same one of the PDCCH parameters 458 has a second particular value, the network node 105 may determine that the configurable ID is not to be UE-specific and thus cause the DMRS sequence indicator 482 to have a second value indicating that the configurable ID is not UE-specific. The PDCCH parameters 458 which may influence the network node 105 to determine whether the configurable ID is to be UE-specific include a subcarrier spacing associated with the first PDCCH candidates 406, a frequency range associated with the first PDCCH candidates 406, a frequency band associated with the first PDCCH candidates 406, a total number of actively monitored components associated with the first PDCCH candidates 406, other parameters, or a combination thereof. As an illustrative example, if the subcarrier spacing associated with the first PDCCH candidates 406 satisfies a threshold, the network node 105 may determine that the configurable ID is to be UE-specific. Although described as the network node 105 determining whether the configurable ID is UE-specific in accordance with one or more of the PDCCH parameters 458, in other implementations, the UE 115 may determine whether to perform the two-stage PDCCH blind detection procedure or the single-stage blind detection procedure in accordance with one or more of the PDCCH parameters 414 (and the DMRS sequence indicator 482), in the same manner as described for the network node 105 and the PDCCH parameters 458.

After receiving the DMRS sequence indicator 482, the UE 115 may perform at least a portion of a PDCCH blind detection procedure in accordance with the DMRS sequence indicator 482. Performing at least a portion of a PDCCH blind detection procedure in accordance with the DMRS sequence indicator 482 may include selecting a type of PDCCH blind detection procedure to perform, selecting one or more parameters associated with the PDCCH blind detection procedure, or a combination thereof. As an example, the UE 115 may determine whether to perform the two-stage PDCCH blind detection procedure or the single-stage PDCCH blind detection procedure based on whether the DMRS sequence indicator 482 indicates that the configurable ID associated with the UE 115 is UE-specific or not. Additionally, or alternatively, the UE 115 may select or identify one or more of the PDCCH parameters 414 in accordance with the DMRS sequence indicator 482. The PDCCH parameters 414 that are identified in view of the DMRS sequence indicator 482 may include a CRC size, a PDCCH blind detection limit, a non-overlapped CCE limit, other parameters associated with the first PDCCH candidates 406 or the second PDCCH candidates 410, or a combination thereof.

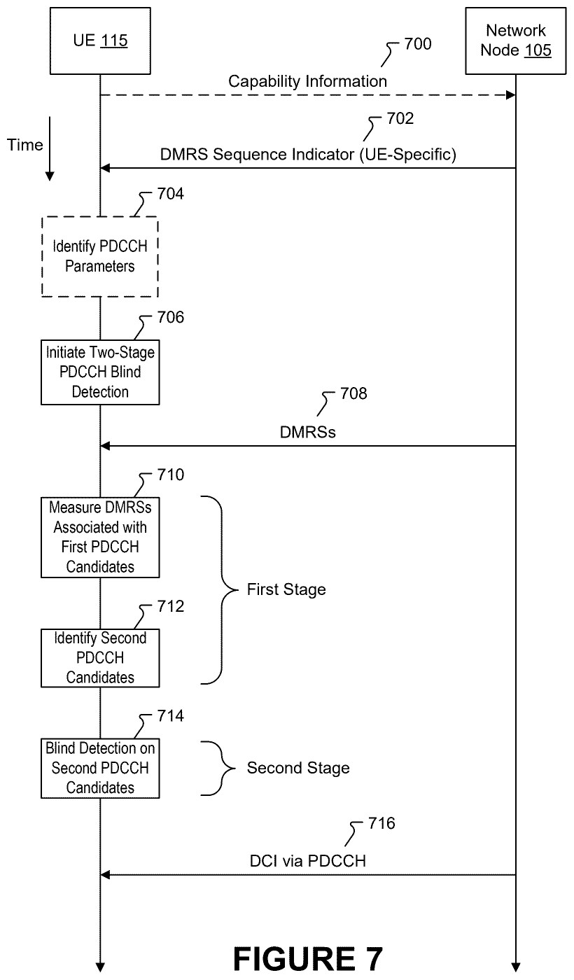

As an example, the UE 115 may identify a CRC size of the PDCCH parameters 414 as having a first value if the DMRS sequence indicator 482 indicates that the configurable ID is UE-specific or as having a second value if the DMRS sequence indicator 482 indicates that the configurable ID is not UE-specific. In this example, the UE 115 may perform a PDCCH blind detection procedure in accordance with the selected CRC size. As another example, the UE 115 may identify a PDCCH blind detection limit of the PDCCH parameters 414 as having a first value if the DMRS sequence indicator 482 indicates that the configurable ID is UE-specific or as having a second value if the DMRS sequence indicator 482 indicates that the configurable ID is not UE-specific. In this example, the UE 115 may perform a PDCCH blind detection procedure in accordance with the selected PDCCH blind detection limit. As another example, the UE 115 may identify a non-overlapped CCE limit of the PDCCH parameters 414 as having a first value if the DMRS sequence indicator 482 indicates that the configurable ID is UE-specific or as having a second value if the DMRS sequence indicator 482 indicates that the configurable ID is not UE-specific. In this example, the UE 115 may perform a PDCCH blind detection procedure in accordance with the selected non-overlapped CCE limit. In these examples, the presence or absence of a UE-specific ID for initializing a DMRS sequence may affect the CRC size of PDCCH candidates, change the way PDCCH blind detection operations are counted, change the way a total number of non-overlapping CCEs covered by PDCCH candidates are counted, or a combination thereof. An example of operations performed by the UE 115 in accordance with an indication of a UE-specific configurable ID is further described herein with reference to FIG. 7.

As described with reference to FIG. 4, the present disclosure provides techniques for supporting network configured a multi-stage PDCCH blind detection procedure. For example, the wireless communication system 400 enables a wireless network, via the network node 105, to configure the UE 115 to perform a two-stage or other multi-stage PDCCH blind detection procedure that uses fewer processing resources and reduces power consumption, or that focuses the performance of blind detection operations on PDCCH candidates that are more likely to be an assigned PDCCH, as compared to a typical single-stage PDCCH blind detection procedure. For example, the operations performed by the UE 115 during the first stage of the two-stage PDCCH blind detection procedure, including measurement of the DMRSs 472 and generation of the DMRS metrics 408, are associated with reduced processing resource usage and less power consumption than performance of blind detection operations on each of the first PDCCH candidates 406 during the first stage. Thus, performing the first stage of the two-stage PDCCH blind detection procedure enables the UE 115 to filter a larger quantity of PDCCH candidates, i.e., the first PDCCH candidates 406, to a smaller quantity of PDCCH candidates, i.e., the second PDCCH candidates 410 using less processing resource and power intensive operations, which reserves the more processing resource and power intensive blind detection operations until after removal one or more PDCCH candidates associated with poor DMRS metrics.

In some implementations, the two-stage PDCCH blind detection procedure reduces a quantity of blind detection operations performed by the UE 115, thereby reducing the overall processing resource usage and power consumption as compared to the typical single-stage PDCCH blind detection procedure. For example, if a size, e.g., a quantity of PDCCH candidates, of the first PDCCH candidates 406 is the same as or close to a PDCCH blind detection limit, then the size of the second PDCCH candidates 410 is smaller than the size of the blind detection limit, which results in fewer blind detection operations and an overall reduction in processing resource usage and power consumption as compared to performing blind detection operations on each of the first PDCCH candidates 406, such as during a typical single-stage PDCCH blind detection procedure. Alternatively, if the size of the second PDCCH candidates 410 is the same as or close to the blind detection limit, the two-stage PDCCH blind detection procedure can enable the UE 115 to search for PDCCHs in a larger search space, i.e., the first PDCCH candidates 406, during the first stage using less processing resource and power intensive operations. In this example, the more processing resource and power intensive blind detection operations are reserved for the second PDCCH candidates 410, which are a filtered set of the first PDCCH candidates 406 and therefore are associated with a higher likelihood of being the assigned PDCCH, which improves the accuracy/success rate of the two-stage PDCCH blind detection procedure as compared to the typical single-stage PDCCH blind detection procedure.

In some implementations, the accuracy or performance of the two-stage PDCCH blind detection procedure performed by the UE 115 is further improved by leveraging the DMRS sequence indicator 482. In aspects, if the UE 115 is configured to determine whether to perform the two-stage PDCCH blind detection procedure, or select one or more of the PDCCH parameters 414, in accordance with whether the DMRS sequence indicator 482 indicates that the DMRS sequence ID assigned to the UE 115 is specific to the UE 115, the UE 115 may configure performance of the blind detection procedure to account for or reduce false positive blind detections associated with non-UE-specific DMRS sequence IDs. For example, if the DMRS sequence indicator 482 indicates that the DMRS sequence ID is not specific to the UE 115, the UE 115 may select a CRC size, a blind detection operation limit, a total number of covered CCEs, or another of the PDCCH parameters 414 to account for an increased likelihood of blind detection false positives. As another example, if the DMRS sequence indicator 482 indicates that the DMRS sequence ID is specific to the UE 115, the UE 115 may select a PDCCH blind detection procedure, such as a single stage procedure or a two-stage procedure, that has better overall performance but that may be prone to errors if a blind detection false positive occurs.

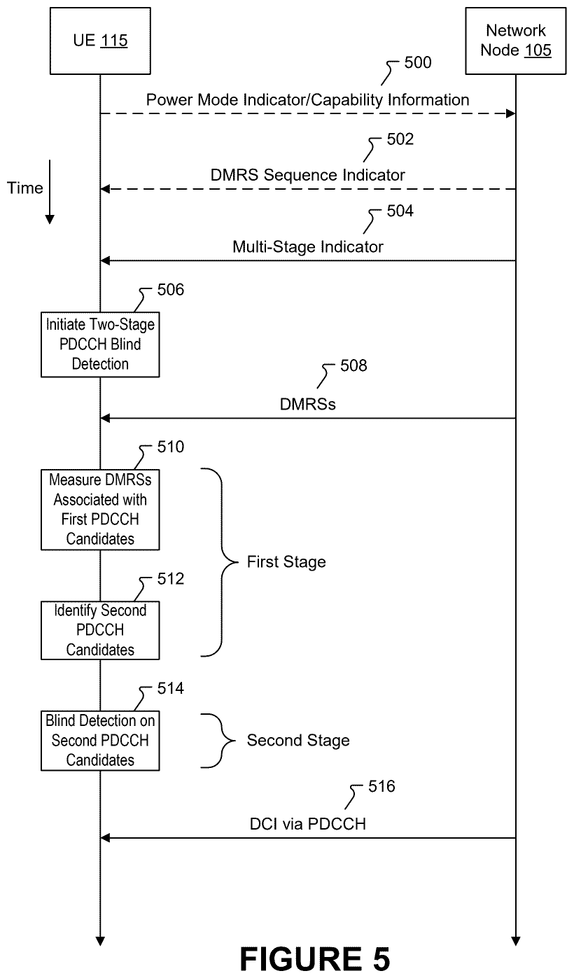

FIGS. 5-8 depict ladder diagrams illustrating various wireless communications to support various aspects of PDCCH blind detection described herein. The operations described with reference to FIGS. 5-8 may be performed by the UE 115 and the network node 105 of FIGS. 1-4. Although operations are illustrated in FIGS. 5-8 as respective arrows and/or blocks, the operations described herein may be performed as a single operation or as multiple operations, and may include communication of one or more signals or messages to support the described functionality. Messages and signaling transmitted from the network node 105 to the UE 115 may be referred to as DL communications, and messages or signaling transmitted from the UE 115 to the network node 105 may be referred to as UL communications. Additionally, or alternatively, although a particular order of operations is illustrated and described with reference to FIGS. 5-8, in other implementations, one or more operations may be performed in a different order or partially or wholly concurrently. Operations depicted using dashed lines are optional, and such operations may not be performed in some implementations described herein.

FIG. 5 is a ladder diagram illustrating example wireless communications that support a network configured multi-stage PDCCH blind detection procedure in accordance with the present disclosure. In the example depicted in FIG. 5, the UE 115 optionally transmits a power mode indicator, capability information, or both, to the network node 105, at 500. For example, the UE 115 may transmit capability information to the network node 105, such as the capability information 478 of FIG. 4, to indicate that the UE 115 is capable of performing a two-stage PDCCH blind detection procedure (or another multi-stage PDCCH blind detection procedure). Additionally, or alternatively, the UE 115 may transmit a power mode indicator to the network node 105, such as the power mode indicator 480 of FIG. 4, to indicate a power mode or power saving at the UE 115. In some implementations, two-stage blind detection of PDCCH candidates may be activated or deactivated based on dynamic indication of power saving at the UE 115, as indicated by the power mode indicator. In some implementations, a predefined processing time may be applied between indication of power saving (or a low power mode) and activation or deactivation of the two-stage PDCCH blind detection procedure by the network node 105. The predefined processing time may include a few milliseconds, such as 1, 2, 10, or 25, as non-limiting examples, or another interval. In some such implementations, the power mode indicator, or a message that includes the power mode indicator, may also include or indicate the predefined processing time (or an interval that the UE 115 requests the network node 105 to wait before activating or deactivating the two-stage PDCCH blind detection procedure).

The network node 105 optionally transmits a DMRS sequence indicator to the UE 115, at 502. For example, the network node 105 may transmit a DMRS sequence indicator to the UE 115, such as the DMRS sequence indicator 482 of FIG. 4, to indicate whether a configurable ID associated with the UE 115 and that is used to initialize a DMRS sequence is specific to the UE (or is shared between multiple UEs). In implementations in which the network node 105 sends the DMRS sequence indicator, the UE 115 may perform at least a portion of a PDCCH blind detection procedure in accordance with the DMRS sequence indicator, such as selecting a type of PDCCH blind detection procedure to perform or values of one or more PDCCH parameters. In some implementations in which the type of PDCCH blind detection procedure performed by the UE 115 is based on whether the configurable ID is UE-specific, instead of sending the DMRS sequence indicator at 502, the network node 105 may transmit a single indicator that indicates whether the configurable ID is UE-specific, which serves as both the DMRS sequence indicator and an indication to perform either the two-stage PDCCH blind detection procedure or the single-stage PDCCH blind detection procedure.

The network node 105 transmits a multi-stage indicator to the UE 115, at 504. For example, the network node 105 may transmit a multi-stage indicator to the UE 115, such as the multi-stage indicator 470 of FIG. 4, that represents an indication to the UE 115 to perform a two-stage PDCCH blind detection procedure. The multi-stage indicator may be a binary indicator or other type of indicator that can represent at least two possible values: a first value indicating that the UE 115 is to perform the two-stage PDCCH blind detection procedure and a second value indicating that the UE 115 is to perform the single-stage PDCCH blind detection procedure. In aspects, the multi-stage indicator may be included in a message sent by the network node 105 during an initialization process associated with establishment of a communication link between the UE 115 and the network node 105 for a static or semi-static indication. Alternatively, the multi-stage indicator may be included in a MAC-CE or DCI sent by the network node 105 for a dynamic indication. In some implementations, a decision whether the UE 115 is to perform the two-stage PDCCH blind detection procedure is decided at the network, such as based on channel parameters associated with a wireless channel between the network node 105 and the UE 115, scheduling of DCI for other UEs by the network node 105, or other information. Alternatively, the network node 105 may determine that the UE 115 is to perform the two-stage PDCCH blind detection procedure at least partially based on information or a request from the UE 115, such as in implementations in which the UE 115 sends the power mode indicator or the capability information.

The UE 115 receives the multi-stage indicator and initiates performance of the two-stage PDCCH blind detection procedure in accordance with the multi-stage indicator, at 506. For example, the UE 115 may initiate performance of the two-stage PDCCH blind detection procedure if the multi-stage indicator indicates that the UE 115 is to perform the two-stage PDCCH blind detection procedure. Alternatively, the UE 115 may initiate performance of the single-stage PDCCH blind detection procedure if the multi-stage indicator indicates that the UE 115 is not to perform the two-stage PDCCH blind detection procedure. In some implementations in which the network node 105 sends the DMRS sequence indicator, the UE 115 initiates performance of the two-stage PDCCH blind detection procedure further in accordance with the DMRS sequence indicator. For example, the UE 115 may initiate performance of the two-stage PDCCH blind detection procedure (or the single-stage PDCCH blind detection procedure) if the DMRS sequence indicator indicates that a configurable ID associated with the UE 115 and used to initialize a DMRS is specific to the UE 115. Alternatively, the UE 115 may initiate performance of the single-stage PDCCH blind detection procedure (or the two-stage PDCCH blind detection procedure) if the DMRS sequence indicator indicates that the configurable ID is not specific to the UE 115. In some implementations, the UE 115 initiates performance of the two-stage PDCCH detecting procedure further in accordance with one or more PDCCH parameters, such as the PDCCH parameters 414 of FIG. 4. For example, the UE 115 may initiate performance of the two-stage PDCCH blind detection procedure if the subcarrier spacing associated with a set of PDCCH candidates has a particular value or is within a particular range, if a frequency range associated with the set of PDCCH candidates is a particular range or within a particular group of ranges, if a frequency band associated with the set of PDCCH candidates is a particular band or within a particular group of bands, or a combination thereof.

The network node 105 transmits DMRSs to the UE 115, at 508. The DMRSs may include the DMRSs 472 of FIG. 4 that transmitted across, or otherwise associated with, the first PDCCH candidates 406 of FIG. 4. Although illustrated in FIG. 5 as occurring after the initiation of the two-stage PDCCH blind detection procedure by the UE 115, in some other implementations, the network node 105 may also transmit the DMRSs prior to the initiation of the two-stage PDCCH blind detection procedure by the UE 115.

During a first stage of the two-stage PDCCH blind detection procedure, the UE 115 measures the DMRSs associated with the first set of PDCCH candidates, at 510. For example, the UE 115 may measure, for one or more PDCCH candidate of the first set of PDCCH candidates, a DMRS associated with the PDCCH candidate. The first set of PDCCH candidates, such as the first PDCCH candidates 406 of FIG. 4, may be indicated by one or more CORESET configurations or by signaling from the network node 105. In some implementations, the UE 115 generates DMRS metrics that include, or are derived from, the DMRS measurements. The DMRS metrics, such as the DMRS metrics 408 of FIG. 4, may include DMRS RSRP, estimated DMRS SINR, metrics calculated or derived from the DMRS RSRP, metrics calculated or derived from the DMRS SINR, estimated BLER (which may also be referred to as a “hypothetical BLER”), other metrics, or a combination thereof. During the first stage of the two-stage PDCCH blind detection procedure, the UE 115 also identifies a second set of PDCCH candidates in accordance with the measurements and/or the DMRS metrics, at 512. For example, the UE 115 may include one or more of the first set of PDCCH candidates in the second set of PDCCH candidates, where each PDCCH candidate included in the second set of PDCCH candidates is associated with a DMRS metric that satisfies a threshold. Additionally, or alternatively, the UE 115 may include a threshold number of PDCCH candidates from the first set of PDCCH candidates that are associated with the largest DMRS metrics in the second set of PDCCH candidates. As such, the first set of PDCCH candidates represents a larger collection of PDCCH candidates that are to be filtered down based on the DMRS measurements to a smaller set of PDCCH candidates for further processing. In some implementations, if no DMRS metric satisfies the threshold, the UE 115 terminates the two-stage PDCCH blind detection procedure at the end of the first stage.

During a second stage of the two-stage PDCCH blind detection procedure, the UE 115 performs blind detection operations on the second set of PDCCH candidates, at 514. For example, the UE 115 may perform, in accordance with the measurements of the DMRSs associated with the first set of PDCCH candidates, for at least one PDCCH candidate of the second set of PDCCH candidates, a blind detection operation on the PDCCH candidate. Performing the blind detection operations on a PDCCH candidate may include estimating a channel associated with the PDCCH candidate and attempting to descramble or decode a CRC portion of the PDCCH candidate using an identifier associated with the UE 115, such as a type of RNTI. If this CRC check is successful, the blind detection operation is referred to as a success, and the UE 115 receives and decodes DCI or other control information within the PDCCH, at 516. If the CRC check is not successful, the blind detection operation is referred to as a failure, and the UE 115 continues to perform blind detection operations on others of the second set of PDCCH candidates. In some implementations, the UE 115 terminates the two-stage PDCCH blind detection procedure upon completion of a successful blind detection operation, or a threshold number of successful blind detection operations. Alternatively, the UE 115 may perform blind detection operations on each of the second set of PDCCH candidates prior to termination of the two-stage PDCCH blind detection procedure.

FIG. 6 is a ladder diagram illustrating example wireless communications that support changing a network configured PDCCH blind detection mode in accordance with the present disclosure. In the example depicted in FIG. 6, the UE 115 performs a two-stage PDCCH blind detection procedure to identify a PDCCH, at 600, and the network node 105 transmits DCI via the PDCCH to the UE 115, at 602. For example, the operations performed by UE 115 at 600 and the operations performed by the network node 105 at 602 may include at least some of the operations described above with reference to FIG. 5.

At a later time after 602, the network node 105 transmits a single-stage indicator to the UE 115, at 604. For example, during a later time period after 602, the network node 105 may determine to change the PDCCH blind detection procedure being performed at the UE 115, and the network node 105 may transmit the single-stage indicator to the UE 115 to initiate a transition to a different PDCCH blind detection procedure. The single-stage indicator may represent an indication to the UE 115 to perform a single-stage PDCCH blind detection procedure. In some implementations, the decision to change the PDCCH blind detection procedure is decided at the network, such as based on information available to the network node 105. Alternatively, the network node 105 may determine to change the PDCCH blind detection procedure based on information received from the UE 115, such as a power mode indicator.

The network node 105 optionally transmits a DMRS sequence indicator to the UE 115, at 606. The DMRS sequence indicator, such as the DMRS sequence indicator 482 of FIG. 4, may indicate a change in whether a configurable ID associated with the UE 115 and used to initialize a DMRS sequence is specific to the UE 115. For example, if the configurable ID has changed from being UE-specific to being associated with multiple UEs, or vice-versa, the network node 105 may transmit the DMRS sequence indicator to update the UE 115 regarding the change. In some implementations, the network node 105 transmits the single-stage indicator and the DMRS sequence indicator as distinct indicators. In some other implementations in which performance of the two-stage PDCCH blind detection procedure is based on whether the configurable ID is UE-specific, the network node 105 transmits a single indicator that indicates that the UE-specific nature of the configurable ID has changed, which is interpreted by the UE 115 as an indication to perform the single-stage PDCCH blind detection procedure.

After receiving the single stage indicator, the UE 115 performs the single-stage PDCCH blind detection procedure, at 608. For example, the UE 115 may perform, for at least one PDCCH candidate of a third set of PDCCH candidates, a blind detection operation on the PDCCH candidate. Performance of the single-stage PDCCH blind detection procedure may be similar to performance of the second stage of the two-stage PDCCH blind detection procedure described above with reference to FIG. 5. The third set of PDCCH candidates may be indicated by one or more CORESET configurations or by signaling from the network node 105, similar to the first set of PDCCH candidates associated with the first stage of the two-stage PDCCH blind detection procedure. In some implementations, the third set of PDCCH candidates is the same as the first set of PDCCH candidates. The blind detection operations include generating channel estimates and performing CRC checks, as described with reference to FIG. 5. If a CRC check is successful, the blind detection operation is successful and the UE 115 receives and decodes DCI or other control information within the PDCCH, at 610. If the CRC check is not successful, the blind detection operation fails, and the UE 115 continues to perform blind detection operations on others of the third set of PDCCH candidates until successful completion of a blind detection operation. If each of the blind detection operations fails, the UE 115 may perform one or more operations to deal with an error condition or may initiate performance of a new PDCCH blind detection procedure.

FIG. 7 is a ladder diagram illustrating example wireless communications that support a network configured multi-stage PDCCH blind detection procedure in accordance with a UE-specific DMRS sequence indication in accordance with the present disclosure. In the example depicted in FIG. 7, the UE 115 optionally transmits capability information to the network node 105, at 700. For example, the UE 115 may transmit capability information to the network node 105, such as the capability information 478 of FIG. 4, to indicate that the UE 115 is capable of performing a two-stage PDCCH blind detection procedure (or another multi-stage PDCCH blind detection procedure), to indicate that the UE 115 is capable of performing different PDCCH blind detection procedures based on whether a configurable ID associated with the UE 115 and used to initialize a DMRS sequence is UE-specific, or both.

The network node 105 transmits a DMRS sequence indicator to the UE 115, at 702. For example, the network node 105 may transmit a DMRS sequence indicator to the UE 115, such as the DMRS sequence indicator 482 of FIG. 4, to indicate whether a configurable ID associated with the UE 115 and that is used to initialize a DMRS sequence is specific to the UE (or is shared between multiple UEs). In the example shown in FIG. 7, the DMRS sequence indicator indicates that the configurable ID is UE-specific. The DMRS sequence indicator may be included in a configuration message associated with a UE-specific CORESET for static or semi-static indication to the UE 115. Additionally, or alternatively, the DMRS sequence indicator may be included in a MAC-CE or DCI from the network node 105 for dynamic indication to the UE 115. The UE 115 may be configured to perform at least a portion of a PDCCH blind detection procedure in accordance with the DMRS sequence indicator, such as selecting a type of PDCCH blind detection procedure to perform or values of one or more PDCCH parameters, as further described herein.

After receiving the DMRS sequence indicator, the UE 115 optionally identifies one or more PDCCH parameters in accordance with the DMRS sequence indicator, at 704, and the UE 115 initiates performance of a two-stage PDCCH blind detection procedure in accordance with the DMRS sequence indicator, at 706. The one or more PDCCH parameters may include a CRC size associated with at least one set of PDCCH candidates, a PDCCH blind detection limit, a non-overlapping CCE limit associated with at least one set of PDCCH candidates, other parameters, or a combination thereof, that can have different values if the configurable ID is UE-specific as compared to if the configurable ID is not UE-specific. As an example, the UE 115 may select a first value of a CRC size for use in performing a PDCCH blind detection procedure because the configurable ID is UE-specific. Additionally, or alternatively, the UE 115 may initiate performance of the two-stage PDCCH blind detection procedure if the configurable ID is UE-specific, as indicated by the DMRS sequence indicator. In some other implementations, the UE 115 may initiate performance of the two-stage PDCCH blind detection procedure if the configurable ID is not UE-specific. In some implementations, the UE 115 initiates performance of the two-stage PDCCH detecting procedure further in accordance with one or more PDCCH parameters. For example, the UE 115 may initiate performance of the two-stage PDCCH blind detection procedure if the subcarrier spacing associated with a set of PDCCH candidates has a particular value or is within a particular range, if a frequency range associated with the set of PDCCH candidates is a particular range or within a particular group of ranges, if a frequency band associated with the set of PDCCH candidates is a particular band or within a particular group of bands, or a combination thereof.

The example shown in FIG. 7 corresponds to performance of the two-stage PDCCH blind detection procedure, but in some other implementations, the UE 115 may initiate performance of a single-stage PDCCH blind detection procedure if the configurable ID is not UE-specific (or if it is UE-specific). FIG. 7 illustrates the operations at 704 as being optional and the operations at 706 as being performed, in other implementations, the UE 115 may perform one or more of the operations in a different manner. For example, the UE 115 may perform the operations at 704 and not the operations at 706, the UE 115 may perform the operations at 706 and not the operations at 704, or the UE 115 may perform the operations at 704 and the operations at 706.

The network node 105 transmits DMRSs to the UE 115, at 708, similar as to described above with reference to FIG. 5. During a first stage of the two-stage PDCCH blind detection procedure, the UE 115 measures the DMRSs associated with a first set of PDCCH candidates, at 710. For example, the UE 115 may measure, for each PDCCH candidate of the first set of PDCCH candidates, a DMRS associated with the PDCCH candidate. The first set of PDCCH candidates, such as the first PDCCH candidates 406 of FIG. 4, may be indicated by one or more CORESET configurations or by signaling from the network node 105. In some implementations, the UE 115 generates DMRS metrics that include, or are derived from, the DMRS measurements. The DMRS metrics, such as the DMRS metrics 408 of FIG. 4, may include DMRS RSRP, estimated DMRS SINR, metrics calculated or derived from the DMRS RSRP, metrics calculated or derived from the DMRS SINR, estimated BLER (which may also be referred to as a “hypothetical BLER”), other metrics, or a combination thereof.

During the first stage of the two-stage PDCCH blind detection procedure, the UE 115 also identifies a second set of PDCCH candidates in accordance with the measurements and/or the DMRS metrics, at 712. For example, the UE 115 may include one or more of the first set of PDCCH candidates in the second set of PDCCH candidates, where each PDCCH candidate included in the second set of PDCCH candidates is associated with a DMRS metric that satisfies a threshold. Additionally, or alternatively, the UE 115 may include a threshold number of PDCCH candidates from the first set of PDCCH candidates that are associated with the largest DMRS metrics in the second set of PDCCH candidates. In some implementations, if no DMRS metric satisfies the threshold, the UE 115 terminates the two-stage PDCCH blind detection procedure at the end of the first stage.

During a second stage of the two-stage PDCCH blind detection procedure, the UE 115 performs blind detection operations on the second set of PDCCH candidates, at 714. For example, the UE 115 may perform, in accordance with the measurements of the DMRSs associated with the first set of PDCCH candidates, for at least one PDCCH candidate of the second set of PDCCH candidates, a blind detection operation on the PDCCH candidate. Performing the blind detection operations on a PDCCH candidate may include estimating a channel associated with the PDCCH candidate and attempting to descramble or decode a CRC portion of the PDCCH candidate using an identifier associated with the UE 115, such as a type of RNTI. If this CRC check is successful, the blind detection operation is referred to as a success, and the UE 115 receives and decodes DCI or other control information within the PDCCH, at 716. If the CRC check is not successful, the blind detection operation is referred to as a failure, and the UE 115 continues to perform blind detection operations on others of the second set of PDCCH candidates. In some implementations in which one or more PDCCH parameters are identified in accordance with the DMRS sequence indicator, the UE 115 performs the first stage, the second stage, or both stages, in accordance with the identified PDCCH parameters. For example, the first set of PDCCH candidates may have a selected CRC size, a quantity of the first set of PDCCH candidates may be less than or equal to a selected PDCCH candidate limit, a total number of non-overlapping CCEs covered by the first set of PDCCH candidates may be less than or equal to a threshold, or a combination thereof. As another example, the second set of PDCCH candidates may have a selected CRC size, a quantity of the second set of PDCCH candidates may be less than or equal to a selected PDCCH candidate limit, a total number of non-overlapping CCEs covered by the second set of PDCCH candidates may be less than or equal to a threshold, or a combination thereof.

FIG. 8 is a ladder diagram illustrating example wireless communications that support a network configured single-stage PDCCH blind detection procedure in accordance with a non-UE-specific DMRS sequence indication in accordance with the present disclosure. In the example depicted in FIG. 8, the UE 115 optionally transmits capability information to the network node 105, at 800. For example, the UE 115 may transmit capability information to the network node 105, such as the capability information 478 of FIG. 4, to indicate that the UE 115 is capable of performing a two-stage PDCCH blind detection procedure (or another multi-stage PDCCH blind detection procedure), to indicate that the UE 115 is capable of performing different PDCCH blind detection procedures based on whether a configurable ID associated with the UE 115 and used to initialize a DMRS sequence is UE-specific, or both.

The network node 105 transmits a DMRS sequence indicator to the UE 115, at 802. For example, the network node 105 may transmit a DMRS sequence indicator to the UE 115, such as the DMRS sequence indicator 482 of FIG. 4, to indicate whether a configurable ID associated with the UE 115 and that is used to initialize a DMRS sequence is specific to the UE (or is shared between multiple UEs). In the example shown in FIG. 8, the DMRS sequence indicator indicates that the configurable ID is not UE-specific. The DMRS sequence indicator may be included in a configuration message associated with a UE-specific CORESET for static or semi-static indication to the UE 115. Additionally, or alternatively, the DMRS sequence indicator may be included in a MAC-CE or DCI from the network node 105 for dynamic indication to the UE 115. The UE 115 may be configured to perform at least a portion of a PDCCH blind detection procedure in accordance with the DMRS sequence indicator, such as selecting a type of PDCCH blind detection procedure to perform or values of one or more PDCCH parameters.

After receiving the DMRS sequence indicator, the UE 115 optionally identifies one or more PDCCH parameters in accordance with the DMRS sequence indicator, at 804, and the UE 115 initiates performance of a single-stage PDCCH blind detection procedure in accordance with the DMRS sequence indicator, at 806. The one or more PDCCH parameters may include a CRC size associated with at least one set of PDCCH candidates, a PDCCH blind detection limit, a non-overlapping CCE limit associated with at least one set of PDCCH candidates, other parameters, or a combination thereof, that can have different values if the configurable ID is UE-specific as compared to if the configurable ID is not UE-specific. As an example, the UE 115 may select a second value of a CRC size for use in performing a PDCCH blind detection procedure because the configurable ID is not UE-specific. Additionally, or alternatively, the UE 115 may initiate performance of the single-stage PDCCH blind detection procedure if the configurable ID is not UE-specific, as indicated by the DMRS sequence indicator. In some other implementations, the UE 115 may initiate performance of the single-stage PDCCH blind detection procedure if the configurable ID is UE-specific. In some implementations, the UE 115 initiates performance of the single-stage PDCCH detecting procedure further in accordance with one or more PDCCH parameters. For example, the UE 115 may initiate performance of the single-stage PDCCH blind detection procedure if the subcarrier spacing associated with a set of PDCCH candidates has a particular value or is within a particular range, if a frequency range associated with the set of PDCCH candidates is a particular range or within a particular group of ranges, if a frequency band associated with the set of PDCCH candidates is a particular band or within a particular group of bands, or a combination thereof.

The example shown in FIG. 8 corresponds to performance of the two-stage PDCCH blind detection procedure, but in some other implementations, the UE 115 may initiate performance of a two-stage PDCCH blind detection procedure if the configurable ID is not UE-specific (or if it is UE-specific). FIG. 8 illustrates the operations at 804 as being optional and the operations at 806 as being performed, in other implementations, the UE 115 may perform one or more of the operations in a different manner. For example, the UE 115 may perform the operations at 804 and not the operations at 806, the UE 115 may perform the operations at 806 and not the operations at 804, or the UE 115 may perform the operations at 804 and the operations at 806.

During the single-stage PDCCH blind detection procedure, the UE 115 performs blind detection operations on a third set of PDCCH candidates, at 808. For example, the UE 115 may perform, for at least one PDCCH candidate of the third set of PDCCH candidates, a blind detection operation on the PDCCH candidate. Performance of the single-stage PDCCH blind detection procedure may be similar to performance of the second stage of the two-stage PDCCH blind detection procedure described above with reference to FIG. 5. The third set of PDCCH candidates may be indicated by one or more CORESET configurations or by signaling from the network node 105, similar to the first set of PDCCH candidates associated with the first stage of the two-stage PDCCH blind detection procedure as described with reference to FIG. 5. In some implementations, the third set of PDCCH candidates is the same as the first set of PDCCH candidates. The blind detection operations include generating channel estimates and performing CRC checks, as described with reference to FIG. 5. If a CRC check is successful, the blind detection operation is successful and the UE 115 receives and decodes DCI or other control information within the PDCCH, at 810. If the CRC check is not successful, the blind detection operation fails, and the UE 115 continues to perform blind detection operations on others of the third set of PDCCH candidates.

FIG. 9 is a flow diagram illustrating an example process 900 that supports a network configured multi-stage PDCCH blind detection procedure in accordance with the present disclosure. Operations of the process 900 may be performed by a UE, such as the UE 115 described above with reference to FIGS. 1-8. For example, example operations (also referred to as “blocks”) of the process 900 may enable the UE to perform a network configured multi-stage PDCCH blind detection procedure, according to some aspects of the present disclosure.

FIG. 10 is a block diagram of an example UE 1000 that supports a network configured multi-stage PDCCH blind detection procedure in accordance with the present disclosure. The UE 1000 may be configured to perform operations, including the blocks of the process 900 described with reference to FIG. 9, to perform a network configured multi-stage PDCCH blind detection procedure. In some implementations, the UE 1000 includes the structure, hardware, and components shown and described with reference to the UE 115 of FIGS. 1-4. For example, the UE 1000 includes the controller 280, which operates to execute logic or computer instructions stored in the memory 282, as well as controlling the components of the UE 1000 that provide the features and functionality of the UE 1000. The UE 1000, under control of the controller 280, transmits and receives signals via wireless radios 1001a-r and the antennas 252a-r. The wireless radios 1001a-r include various components and hardware, as illustrated in FIG. 2 for the UE 115, including the modems 254 a-r, the MIMO detector 256, the receive processor 258, the transmit processor 264, and the TX MIMO processor 266.

As shown, the memory 282 may include the PDCCH blind detection manager 150, first PDCCH candidates 1002, DMRS metrics 1003, and second PDCCH candidates 1004. Although illustrated in FIG. 10 as being included in the memory 282, in other implementations, the PDCCH blind detection manager 150 may be a separate component of the UE 1000. The PDCCH blind detection manager 150 may be configured to manage one or more operations supporting a network configured multi-stage PDCCH blind detection procedure, such as measuring DMRSs associated with the first PDCCH candidates 1002 to generate the DMRS metrics 1003 or performing blind detection operations on the second PDCCH candidates 1004. The first PDCCH candidates 1002 may include or correspond to the first PDCCH candidates 406 of FIG. 4. The DMRS metrics 1003 may include or correspond to the DMRS metrics 408 of FIG. 4. The second PDCCH candidates 1004 may include or correspond to the second PDCCH candidates 410 of FIG. 4. The UE 1000 may receive signals from or transmit signals to one or more network nodes, such as the network node 105 of FIGS. 1-8, a network node as illustrated in FIG. 12, or a network node as illustrated in FIG. 16.

Referring back to the process 900 of FIG. 9, in block 902, the UE 1000 receives, from a network node, an indication to the UE to use a two-stage PDCCH blind detection procedure. For example, the network node may include or correspond to the network node 105 of FIGS. 1-8. The indication may include or correspond to the multi-stage indicator 470 of FIG. 4. In some implementations, the UE 1000 receives, from the network node, a message during an initialization process associated with establishment of a communication link between the UE and the network node, and the message includes or indicates the indication. Alternatively, the UE 1000 receives, from the network node, a MAC-CE or DCI that includes the indication.

In block 904, the UE 1000 performs, in accordance with receiving the indication, the two-stage PDCCH blind detection procedure. In some implementations, the UE 1000 performs the two-stage PDCCH blind detection procedure further in accordance with a subcarrier spacing associated with the first set of PDCCH candidates, a frequency range associated with the first set of PDCCH candidates, a frequency band associated with the first set of PDCCH candidates, or a combination thereof.

The two-stage PDCCH blind detection procedure includes, in block 906, the UE 1000 measuring, in a first stage of the two-stage PDCCH blind detection procedure, for each PDCCH candidate of a first set of PDCCH candidates, a DMRS associated with the PDCCH candidate. For example, the first set of PDCCH candidates may include or correspond to the first PDCCH candidates 406 of FIG. 4. The DMRS may include or correspond to the DMRSs 472 of FIG. 4. The two-stage PDCCH blind detection procedure also includes, in block 908, the UE 1000 performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. For example, the measurements of the DMRSs may include or correspond to the DMRS metrics 408 of FIG. 4. The second set of PDCCH candidates may include or correspond to the second PDCCH candidates 410 of FIG. 4.

In some implementations of the process 900, the UE 1000 identifies the first set of PDCCH candidates in accordance with a first set of parameters associated with one or more CORESETs. For example, the first set of parameters may include or correspond to the PDCCH parameters 414 of FIG. 4. Additionally, or alternatively, the UE 1000 identifies the second set of PDCCH candidates in accordance with the measurements of the DMRSs associated with the first set of PDCCH candidates and a second set of parameters. For example, the second set of parameters may include or correspond to the PDCCH parameters 414 of FIG. 4. The second set of parameters may include a PDCCH blind detection limit, a non-overlapped CCE limit, or both.

In some implementations, the UE 1000 receives, from the network node, an indicator to the UE that an ID associated with initializing a DMRS sequence is specific to the UE. For example, the indicator may include or correspond to the DMRS sequence indicator 482 of FIG. 4. In some such implementations, the UE 1000 performs the two-stage PDCCH blind detection procedure further in accordance with the indicator.

In block 910, the UE 1000 receives, from the network node, control information via a PDCCH candidate, from the second set of PDCCH candidates, in accordance with the performance of the blind detection operation on the PDCCH candidate. For example, the control information may include or correspond to the DCI 476 of FIG. 4. The PDCCH candidate via which the control information is received may include or correspond to the selected PDCCH 412.

In some implementations of the process 900, the UE 1000 generates, for each PDCCH candidate of the first set of PDCCH candidates, a DMRS metric associated with the PDCCH candidate in accordance with a measurement of the DMRS associated with the PDCCH candidate. For example, the DMRS metric may include or correspond to the DMRS metrics 408 of FIG. 4. In some examples, the DMRS metric includes a DMRS RSRP, an estimated DMRS SINR, a metric calculated in accordance with the DMRS RSRP, or a metric calculated in accordance with the DMRS SINR. The UE 1000 can identify the PDCCH candidate in the second set of PDCCH candidates in accordance with the DMRS metric associated with the PDCCH candidate satisfying a threshold or with the DMRS metric associated with the PDCCH candidate being one of a threshold number of largest DMRS metrics generated in accordance with the first set of PDCCH candidates.

In some implementations, the UE 1000 transmits, to the network node, a message that indicates a blind detection capability of the UE 1000. The message that indicates the blind detection capability may include or correspond to the capability information 478 of FIG. 4. In some such implementations of the process 900, the indication is received in accordance with the transmission of the message. Additionally, or alternatively, the UE 1000 transmits, to the network node, an indicator that indicates a power mode of the UE. The indicator may include or correspond to the power mode indicator 480 of FIG. 4. In some such implementations, the indication is received in accordance with the transmission of the indicator.

In some implementations of the process 900, the UE 1000 receives, from the network node, a second indication to the UE to use a single-stage PDCCH blind detection procedure during a subsequent time period. In accordance with the second indication, the UE 1000 may perform the single-stage PDCCH blind detection procedure, as further described herein with reference to FIG. 6. The performance of the single-stage PDCCH blind detection procedure may include the UE 1000 performing, for at least one PDCCH candidate of a third set of PDCCH candidates, a blind detection operation on the PDCCH candidate. In some such implementations, the UE 1000 can receive, from the network node, additional control information via a PDCCH candidate, from the third set of PDCCH candidates, in accordance with the performance of the blind detection operation on the PDCCH candidate.

FIG. 11 is a flow diagram illustrating an example process 1100 that supports a network configured multi-stage PDCCH blind detection procedure in accordance with the present disclosure. Operations of the process 1100 may be performed by a network node, such as the network node 105 described above with reference to FIGS. 1-8. For example, example operations of the process 1100 may enable a network node to perform a network configured multi-stage PDCCH blind detection procedure.

FIG. 12 is a block diagram of an example network node 1200 that supports a network configured multi-stage PDCCH blind detection procedure in accordance with the present disclosure. The network node 1200 may be configured to perform operations, including the blocks of the process 1100 described with reference to FIG. 11, to perform a network configured multi-stage PDCCH blind detection procedure. In some implementations, the network node 1200 includes the structure, hardware, and components shown and described with reference to the network node 105 of FIG. 2 or 4. For example, the network node 1200 may include the controller 240, which operates to execute logic or computer instructions stored in the memory 242, as well as controlling the components of the network node 1200 that provide the features and functionality of the network node 1200. The network node 1200, under control of the controller 240, transmits and receives signals via wireless radios 1201a-t and the antennas 234a-t. The wireless radios 1201a-t include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the PDCCH blind detection manager 152, a multi-stage indication 1202, DMRS sequences 1203, and control information 1204. Although illustrated in FIG. 12 as being included in the memory 242, in other implementations, the PDCCH blind detection manager 152 may be a separate component of the network node 1200. The PDCCH blind detection manager 152 may be configured to manage one or more operations supporting a network configured multi-stage PDCCH blind detection procedure, such as transmitting the multi-stage indication 1202, transmitting DMRSs that are initialized using the DMRS sequences 1203, or transmitting the control information 1204. The multi-stage indication 1202 may include or correspond to the multi-stage indicator 470 of FIG. 4. The DMRS sequences 1203 may include or correspond to the DMRS sequences 456 of FIG. 4. The control information 1204 may include or correspond to the DCI 476 of FIG. 4. The network node 1200 may receive signals from or transmit signals to one or more UEs, such as the UE 115 of FIGS. 1-8, the UE 1000 of FIG. 10, or a UE of FIG. 14.

Referring back to the process 1100 of FIG. 11, in block 1102, the network node 1200 transmits, to a UE, an indication to the UE to use a two-stage PDCCH blind detection procedure. For example, the UE may include or correspond to the UE 115 of FIGS. 1-8. The indication may include or correspond to the multi-sage indicator 470 of FIG. 4.

In some implementations, the network node 1200 transmits, to the UE, a message during an initialization process associated with establishment of a communication link between the UE and the network node. In some such implementations, the message includes the indication. In some other implementations of the process 1100, the network node 1200 transmits, to the UE, a MAC-CE that includes the indication. Alternatively, the network node transmits, to the UE, DCI that includes the indication.

In some implementations, the network node 1200 receives, from the UE, a message that indicates a blind detection capability of the UE or an indicator that indicates a power mode of the UE. For example, the message that indicates the blind detection capability may include or correspond to the capability information 478 of FIG. 4. As another example, the indicator that indicates the power mode may include or correspond to the power mode indicator 480 of FIG. 4. The network node 1200 may transmit the indication in accordance with the message that indicates the blind detection capability or the indicator that indicates the power mode.

In block 1104, the network node 1200 transmits, to the UE, and in accordance with a first stage of the two-stage PDCCH blind detection procedure, one or more DMRSs associated with a first set of PDCCH candidates of the first stage. For example, the one or more DMRSs may include or correspond to the DMRSs 472 of FIG. 4. The first set of PDCCH candidates may include or correspond to the first PDCCH candidates 406 of FIG. 4.

In some implementations of the process 1100, the network node 1200 transmits, to the UE, an indicator to the UE that an ID associated with initializing a DMRS sequence is specific to the UE. For example, the indicator may include or correspond to the DMRS sequence indicator 482 of FIG. 4.

In block 1106, the network node 1200 transmits, to the UE, and in accordance with a second stage of the two-stage PDCCH blind detection procedure, control information via a PDCCH of a second set of PDCCH candidates identified from the first set of PDCCH candidates at the UE in accordance with the second stage. For example, the control information may include or correspond to the DCI 476 of FIG. 4. The second set of PDCCH candidates may include or correspond to the second PDCCH candidates 410 of FIG. 4.

FIG. 13 is a flow diagram illustrating an example process 1300 that supports a DMRS sequence specificity-based PDCCH blind detection procedure in accordance with the present disclosure. Operations of the process 1300 may be performed by a UE, such as the UE 115 described above with reference to FIGS. 1-8. For example, example operations of the process 1300 may enable the UE to perform a DMRS sequence specificity-based PDCCH blind detection procedure, according to some aspects of the present disclosure.

FIG. 14 is a block diagram of an example UE 1400 that supports a DMRS sequence specificity-based PDCCH blind detection procedure in accordance with the present disclosure. The UE 1400 may be configured to perform operations, including the blocks of the process 1300 described with reference to FIG. 13, to perform a DMRS sequence specificity-based PDCCH blind detection procedure. In some implementations, the UE 1400 includes the structure, hardware, and components shown and described with reference to the UE 115 of FIG. 2 or 4. For example, the UE 1400 includes the controller 280, which operates to execute logic or computer instructions stored in the memory 282, as well as controlling the components of the UE 1400 that provide the features and functionality of the UE 1400. The UE 1400, under control of the controller 280, transmits and receives signals via wireless radios 1401a-r and the antennas 252a-r. The wireless radios 1401a-r include various components and hardware, as illustrated in FIG. 2 for the UE 115, including the modems 254 a-r, the MIMO detector 256, the receive processor 258, the transmit processor 264, and the TX MIMO processor 266.

As shown, the memory 282 may include the PDCCH blind detection manager 150, a received indicator 1402, PDCCH parameters 1403, and PDCCH candidates 1404. Although illustrated in FIG. 14 as being included in the memory 282, in other implementations, the PDCCH blind detection manager 150 may be a separate component of the UE 1400. The PDCCH blind detection manager 150 may be configured to manage one or more operations supporting a DMRS sequence specificity-based PDCCH blind detection procedure, such as receiving an indication (e.g., the received indicator 1402) of whether a DMRS sequence is unique to the UE 1400, selecting one or more of the PDCCH parameters 1403 in accordance with the received indicator 1402, and/or performing PDCCH blind detection operations on the PDCCH candidates 1404 in accordance with the received indicator 1402 and the PDCCH parameters 1403. The received indicator 1402 may include or correspond to the DMRS sequence indicator 482 of FIG. 4. The PDCCH parameters 1403 may include or correspond to the PDCCH parameters 414 of FIG. 4. The PDCCH candidates 1404 may include or correspond to the first PDCCH candidates 406 or the second PDCCH candidates 410 of FIG. 4. The UE 1400 may receive signals from or transmit signals to one or more network nodes, such as the network node 105 of FIGS. 1-8 or a network node as illustrated in FIG. 16.

Referring back to the process 1300 of FIG. 13, in block 1302, the UE 1400 receives, from a network node, an indication to the UE 1400 that an ID associated with initializing a DMRS sequence is specific to the UE. For example, the network node may include or correspond to the network node 105 of FIGS. 1-8. The indication may include or correspond to the DMRS sequence indicator 482 of FIG. 4.

In some implementations, to receive the indication, the UE 1400 receives, from the network node, a configuration message associated with a UE-specific CORESET for the UE. The configuration message may include or indicate the indication. Alternatively, to receive the indication, the UE 1400 receives a MAC-CE or DCI, and the MAC-CE or the DCI may include or indicate the indication.

In block 1304, the UE 1400 performs, in accordance with the indication, at least a portion of a PDCCH blind detection procedure on a set of PDCCH candidates. For example, the set of PDCCH candidates may include or correspond to the first PDCCH candidates 406 or the second PDCCH candidates 410 of FIG. 4. In some implementations, the UE 1400 to performs at least the portion of the PDCCH blind detection procedure on the set of PDCCH candidates further in accordance with a subcarrier spacing associated with the set of PDCCH candidates, a frequency range associated with the set of PDCCH candidates, a frequency band associated with the set of PDCCH candidates, or a combination thereof.

In some implementations, the UE 1400 identifies a CRC size in accordance with the indication. In some such implementations, the UE 1400 performs CRC decoding on the control information in accordance with the CRC size. Additionally, or alternatively, the UE 1400 may identify a PDCCH blind detection limit in accordance with the indication. In some such implementations of the process 1300, the UE 1400 performs the PDCCH blind detection procedure in accordance with the PDCCH blind detection limit. Additionally, or alternatively, the UE 1400 can identify a non-overlapped CCE limit in accordance with the indication. In some such implementations, the UE 1400 performs the PDCCH blind detection procedure in accordance with the non-overlapped CCE limit. The CRC size, the PDCCH blind detection limit, the non-overlapped CCE limit, or a combination thereof, may include or correspond to the PDCCH parameters 414 of FIG. 4.

In block 1306, the UE 1400 receives, from the network node, control information via a PDCCH candidate, from the set of PDCCH candidates, in accordance with performance of the blind detection procedure on the PDCCH candidate. For example, the control information may include or correspond to the DCI 476 of FIG. 4.

In some implementations of the process 1300, the UE 1400 transmits, to the network node, a message indicating a PDCCH blind detection capability of the UE. For example, the message indicating the PDCCH blind detection capability may include or correspond to the capability information 478 of FIG. 4. In some such implementations, the indication is received by the UE 1400 in accordance with the transmission of the message.

FIG. 15 is a flow diagram illustrating an example process 1500 that supports a DMRS sequence specificity-based PDCCH blind detection procedure in accordance with the present disclosure. Operations of the process 1500 may be performed by a network node, such as the network node 105 described above with reference to FIGS. 1-8. For example, example operations of the process 1500 may enable a network node to perform a DMRS sequence specificity-based PDCCH blind detection procedure.

FIG. 16 is a block diagram of an example network node 1600 that supports a DMRS sequence specificity-based PDCCH blind detection procedure in accordance with the present disclosure. The network node 1600 may be configured to perform operations, including the blocks of the process 1500 described with reference to FIG. 15, to perform a DMRS sequence specificity-based PDCCH blind detection procedure. In some implementations, the network node 1600 includes the structure, hardware, and components shown and described with reference to the network node 105 of FIG. 2 or 4. For example, the network node 1600 may include the controller 240, which operates to execute logic or computer instructions stored in the memory 242, as well as controlling the components of the network node 1600 that provide the features and functionality of the network node 1600. The network node 1600, under control of the controller 240, transmits and receives signals via wireless radios 1601a-t and the antennas 234a-t. The wireless radios 1601a-t include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the PDCCH blind detection manager 152, a DMRS sequence indicator 1602, PDCCH parameters 1603, and control information 1604. Although illustrated in FIG. 16 as being included in the memory 242, in other implementations, the PDCCH blind detection manager 152 may be a separate component of the network node 1600. The PDCCH blind detection manager 152 may be configured to manage one or more operations supporting a DMRS sequence specificity-based PDCCH blind detection procedure, such as transmitting the DMRS sequence indicator 1602 and/or transmitting the control information 1604 in accordance with the DMRS sequence indicator 1602 and the PDCCH parameters 1603. The DMRS sequence indicator 1602 may include or correspond to the DMRS sequence indicator 482 of FIG. 4. The PDCCH parameters 1603 may include or correspond to the PDCCH parameters 458 of FIG. 4. The control information 1604 may include or correspond to the DCI 476 of FIG. 4. The network node 1600 may receive signals from or transmit signals to one or more UEs, such as the UE 115 of FIGS. 1-8 or the UE 1400 of FIG. 14.

Referring back to the process 1500 of FIG. 15, in block 1502, the network node 1600 transmits, to a UE, an indication to the UE that an ID associated with initializing a DMRS sequence is specific to the UE. For example, the UE may include or correspond to the UE 115 of FIGS. 1-8. The indication may include or correspond to the DMRS sequence indicator 482 of FIG. 4.

In some implementations, the network node 1600 transmits, to the UE, a configuration message associated with a UE-specific CORESET for the UE. The configuration message may include the indication. In some other implementations, to transmit the indication, the network node 1600 transmits a MAC-CE or DCI to the UE. The MAC-CE or the DCI may include the indication.

In some implementations, the network node 1600 receives, from the UE, a message indicating a PDCCH blind detection capability of the UE. The message indicating the PDCCH blind detection capability may include or correspond to the capability information 478 of FIG. 4. In some such implementations, the indication is transmitted in accordance with the transmission of the message that indicates the PDCCH blind detection capability.

In block 1504, the network node 1600 transmits, to the UE, and in accordance with a PDCCH blind detection procedure that is associated with the indication, control information via a PDCCH. For example, the control information may include or correspond to the DCI 476 of FIG. 4.

It is noted that one or more blocks (or operations) described with reference to FIGS. 9, 11, 13, and 15 may be combined with one or more blocks (or operations) described with reference to another of the figures. For example, one or more blocks (or operations) of FIG. 9 may be combined with one or more blocks (or operations) of FIG. 13, or one or more blocks (or operations) of FIG. 11 may be combined with one or more blocks (or operations) of FIG. 15. As another example, one or more blocks associated with FIG. 9, 11, 13, or 15 may be combined with one or more blocks (or operations) associated with FIGS. 1-8. Additionally, or alternatively, one or more operations described above with reference to FIGS. 1-8 may be combined with one or more operations described with reference to FIG. 10, 12, 14, or 16.

In the following, further examples are described to facilitate the understanding of the disclosure.

According to Example 1, a UE for wireless communication includes: a processing system that includes one or more processors; and one or more memories coupled with the one or more processors. The processing system is configured to cause the UE to receive, from a network node, an indication to the UE to use a two-stage PDCCH blind detection procedure. The processing system is also configured to cause the UE to perform, in accordance with receiving the indication, the two-stage PDCCH blind detection procedure. The performance of the two-stage PDCCH blind detection procedure includes measuring, in a first stage of the two-stage PDCCH blind detection procedure, for each PDCCH candidate of a first set of PDCCH candidates, a DMRS associated with the PDCCH candidate. The performance of the two-stage PDCCH blind detection procedure also includes performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate. The processing system is further configured to receive, from the network node, control information via a PDCCH candidate, from the second set of PDCCH candidates, in accordance with the performance of the blind detection operation on the PDCCH candidate.

Example 2 includes the UE of Example 1, where the processing system is further configured to cause the UE to: generate, for each PDCCH candidate of the first set of PDCCH candidates, a DMRS metric associated with the PDCCH candidate in accordance with a measurement of the DMRS associated with the PDCCH candidate; and include the PDCCH candidate in the second set of PDCCH candidates in accordance with the DMRS metric associated with the PDCCH candidate satisfying a threshold or with the DMRS metric associated with the PDCCH candidate being one of a threshold number of largest DMRS metrics generated in accordance with the first set of PDCCH candidates.

Example 3 includes the UE of Example 2, where the DMRS metric includes a DMRS RSRP, an estimated DMRS SINR, a metric calculated in accordance with the DMRS RSRP, or a metric calculated in accordance with the DMRS SINR.

Example 4 includes the UE of any of Examples 1 to 3, where the processing system is configured to cause the UE to perform the two-stage PDCCH blind detection procedure further in accordance with a subcarrier spacing associated with the first set of PDCCH candidates, a frequency range associated with the first set of PDCCH candidates, a frequency band associated with the first set of PDCCH candidates, or a combination thereof.

Example 5 includes the UE of any of Examples 1 to 4, where the processing system is further configured to cause the UE to: receive, from the network node, a message during an initialization process associated with establishment of a communication link between the UE and the network node, and where the message includes the indication.

Example 6 includes the UE of any of Examples 1 to 4, where the processing system is further configured to cause the UE to: receive, from the network node, an MAC-CE or DCI, and where the MAC-CE or the DCI includes the indication.

Example 7 includes the UE of any of Examples 1 to 6, where the processing system is further configured to cause the UE to: transmit, to the network node, a message that indicates a blind detection capability of the UE, where the indication is received in accordance with the transmission of the message.

Example 8 includes the UE of any of Examples 1 to 7, where the processing system is further configured to cause the UE to: receive, from the network node, a second indication to the UE to use a single-stage PDCCH blind detection procedure during a subsequent time period; perform, in accordance with the second indication, the single-stage PDCCH blind detection procedure. The performance of the single-stage PDCCH blind detection procedure includes performing, for at least one PDCCH candidate of a third set of PDCCH candidates, a blind detection operation on the PDCCH candidate. The processing system is also configured to cause the UE to receive, from the network node, additional control information via a PDCCH candidate, from the third set of PDCCH candidates, in accordance with the performance of the blind detection operation on the PDCCH candidate.

Example 9 includes the UE of any of Examples 1 to 8, where the processing system is further configured to cause the UE to: transmit, to the network node, an indicator that indicates a power mode of the UE, where the indication is received in accordance with the transmission of the indicator.

Example 10 includes the UE of any of Examples 1 to 9, where the processing system is further configured to cause the UE to: identify the first set of PDCCH candidates in accordance with a first set of parameters associated with one or more CORESETs; and identify the second set of PDCCH candidates in accordance with the measurements of the DMRSs associated with the first set of PDCCH candidates and a second set of parameters, and where the second set of parameters include a PDCCH blind detection limit, a non-overlapped CCE limit, or both.

Example 11 includes the UE of any of Examples 1 to 10, where the processing system is further configured to cause the UE to: receive, from the network node, an indicator to the UE that an ID associated with initializing a DMRS sequence is specific to the UE; and perform the two-stage PDCCH blind detection procedure further in accordance with the indicator.

According to Example 12, a method of wireless communication by a UE, includes receiving, from a network node, an indication to the UE to use a two-stage PDCCH blind detection procedure; performing, in accordance with the indication, the two-stage PDCCH blind detection procedure, the performance of the two-stage PDCCH blind detection procedure including: measuring, in a first stage of the two-stage PDCCH blind detection procedure, for each PDCCH candidate of a first set of PDCCH candidates, a DMRS associated with the PDCCH candidate; and performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate; and receiving, from the network node, control information via a PDCCH candidate, from the second set of PDCCH candidates, in accordance with the performance of the blind detection operation on the PDCCH candidate.

Example 13 includes the method of Example 12, and the method further includes generating, for each PDCCH candidate of the first set of PDCCH candidates, a DMRS metric associated with the PDCCH candidate in accordance with a measurement of the DMRS associated with the PDCCH candidate; and including the PDCCH candidate in the second set of PDCCH candidates in accordance with the DMRS metric associated with the PDCCH candidate satisfying a threshold or with the DMRS metric associated with the PDCCH candidate being one of a threshold number of largest DMRS metrics generated in accordance with the first set of PDCCH candidates.

Example 14 includes the method of Example 13, where the DMRS metric includes a DMRS RSRP, an estimated DMRS SINR, a metric calculated in accordance with the DMRS RSRP, or a metric calculated in accordance with the DMRS SINR.

Example 15 includes the method of any of Examples 12 to 14, where the performance of the two-stage PDCCH blind detection procedure is further in accordance with a subcarrier spacing associated with the first set of PDCCH candidates, a frequency range associated with the first set of PDCCH candidates, a frequency band associated with the first set of PDCCH candidates, or a combination thereof.

Example 16 includes the method of any of Examples 12 to 15, and the method further includes receiving, from the network node, a message during an initialization process associated with establishment of a communication link between the UE and the network node, and where the message includes the indication.

Example 17 includes the method of any of Examples 12 to 15, and the method further includes receiving, from the network node, a MAC-CE or DCI, and where the MAC-CE or the DCI includes the indication.

Example 18 includes the method of any of Examples 12 to 17, and the method further includes transmitting, to the network node, a message that indicates a blind detection capability of the UE, where the indication is received in accordance with the transmission of the message.

Example 19 includes the method of any of Examples 12 to 18, and the method further includes receiving, from the network node, a second indication to the UE to use a single-stage PDCCH blind detection procedure during a subsequent time period; performing, in accordance with the second indication, the single-stage PDCCH blind detection procedure, the performance of the single-stage PDCCH blind detection procedure including: performing, for at least one PDCCH candidate of a third set of PDCCH candidates, a blind detection operation on the PDCCH candidate; and receiving, from the network node, additional control information via a PDCCH candidate from the third set of PDCCH candidates, in accordance with the performance of the blind detection operation on the PDCCH candidate.

Example 20 includes the method of any of Examples 12 to 19, and the method further includes transmitting, to the network node, an indicator that indicates a power mode of the UE, where the indication is received in accordance with the transmission of the indicator.

Example 21 includes the method of any of Examples 12 to 20, and the method further includes identifying the first set of PDCCH candidates in accordance with a first set of parameters associated with one or more CORESETs; and identifying the second set of PDCCH candidates in accordance with the measurements of the DMRSs associated with the first set of PDCCH candidates and a second set of parameters, and where the second set of parameters include a PDCCH blind detection limit, a non-overlapped CCE limit, or both.

Example 22 includes the method of any of Examples 12 to 21, and the method further includes receiving, from the network node, an indicator to the UE that an ID associated with initializing a DMRS sequence is specific to the UE; and performing the two-stage PDCCH blind detection procedure further in accordance with the indicator.

According to Example 23, a network node for wireless communication, includes a processing system that includes one or more processors and one or more memories coupled with the one or more processors, the processing system configured to cause the network node to: transmit, to a UE, an indication to the UE to use a two-stage PDCCH blind detection procedure; transmit, to the UE, and in accordance with a first stage of the two-stage PDCCH blind detection procedure, one or more DMRSs associated with a first set of PDCCH candidates of the first stage; and transmit, to the UE, and in accordance with a second stage of the two-stage PDCCH blind detection procedure, control information via a PDCCH of a second set of PDCCH candidates identified from the first set of PDCCH candidates at the UE in accordance with the second stage.

Example 24 includes the network node of Example 23, where the processing system is further configured to cause the network node to: transmit, to the UE, a message during an initialization process associated with establishment of a communication link between the UE and the network node, the message including the indication; transmit, to the UE, an MAC-CE that includes the indication; or transmit, to the UE, DCI that includes the indication.

Example 25 includes the network node of Example 23 or Example 24, where the processing system is further configured to cause the network node to: receive, from the UE, a message that indicates a blind detection capability of the UE or an indicator that indicates a power mode of the UE, where the indication is transmitted in accordance with the message or the indicator.

Example 26 includes the network node of any of Examples 23 to 25, where the processing system is further configured to cause the network node to: transmit, to the UE, an indicator to the UE that an ID associated with initializing a DMRS sequence is specific to the UE.

According to Example 27, a method of wireless communication by a network node, includes transmitting, to a UE, an indication to the UE to use a two-stage PDCCH blind detection procedure; transmitting, to the UE, and in accordance with a first stage of the two-stage PDCCH blind detection procedure, one or more DMRSs associated with a first set of PDCCH candidates of the first stage; and transmitting, to the UE, and in accordance with a second stage of the two-stage PDCCH blind detection procedure, control information via a PDCCH of a second set of PDCCH candidates identified from the first set of PDCCH candidates at the UE in accordance with the second stage.

Example 28 includes the method of Example 27, and the method further includes transmitting, to the UE, a message during an initialization process associated with establishment of a communication link between the UE and the network node, the message including the indication; transmitting, to the UE, an MAC-CE that includes the indication; or transmitting, to the UE, DCI that includes the indication.

Example 29 includes the method of Example 27 or Example 28, and the method further includes receiving, from the UE, a message that indicates a blind detection capability of the UE or an indicator that indicates a power mode of the UE, where the indication is transmitted in accordance with the message or the indicator.

Example 30 includes the method of any of Examples 27 to 29, and the method further includes transmitting, to the UE, an indicator to the UE that an ID associated with initializing a DMRS sequence is specific to the UE.

According to Example 31, a UE for wireless communication, the UE includes a processing system that includes one or more processors and one or more memories coupled with the one or more processors, the processing system configured to cause the UE to: receive, from a network node, an indication to the UE that an ID associated with initializing a DMRS sequence is specific to the UE; perform, in accordance with the indication, at least a portion of a PDCCH blind detection procedure on a set of PDCCH candidates; and receive, from the network node, control information via a PDCCH candidate, from the set of PDCCH candidates, in accordance with performance of the blind detection procedure on the PDCCH candidate.

Example 32 includes the UE of Example 31, where, to receive the indication, the processing system is configured to cause the UE to: receive, from the network node, a configuration message associated with a UE-specific CORESET for the UE, where the configuration message includes the indication.

Example 33 includes the UE of Example 31, where, to receive the indication, the processing system is configured to cause the UE to: receive, from the network node, an MAC-CE or DCI, where the MAC-CE or the DCI includes the indication.

Example 34 includes the UE of any of Examples 31 to 33, where the processing system is further configured to cause the UE to: identify a CRC size in accordance with the indication; and perform CRC decoding on the control information in accordance with the CRC size.

Example 35 includes the UE of any of Examples 31 to 34, where the processing system is further configured to cause the UE to: identify a PDCCH blind detection limit in accordance with the indication; and perform the PDCCH blind detection procedure in accordance with the PDCCH blind detection limit.

Example 36 includes the UE of any of Examples 31 to 35, where the processing system is further configured to cause the UE to: identify a non-overlapped CCE limit in accordance with the indication; and perform the PDCCH blind detection procedure in accordance with the non-overlapped CCE limit.

Example 37 includes the UE of any of Examples 31 to 36, where the processing system is further configured to cause the UE to: transmit, to the network node, a message indicating a PDCCH blind detection capability of the UE, where the indication is received in accordance with the transmission of the message.

Example 38 includes the UE of any of Examples 31 to 37, where the processing system is configured to cause the UE to perform at least the portion of the PDCCH blind detection procedure on the set of PDCCH candidates further in accordance with a subcarrier spacing associated with the set of PDCCH candidates, a frequency range associated with the set of PDCCH candidates, a frequency band associated with the set of PDCCH candidates, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-16 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, an indication to the UE to use a two-stage physical downlink control channel (PDCCH) blind detection procedure;
perform, in accordance with receiving the indication, the two-stage PDCCH blind detection procedure, the performance of the two-stage PDCCH blind detection procedure including:
measuring, in a first stage of the two-stage PDCCH blind detection procedure, for each PDCCH candidate of a first set of PDCCH candidates, a demodulation reference signal (DMRS) associated with the PDCCH candidate; and
performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate; and
receive, from the network node, control information via a PDCCH candidate, from the second set of PDCCH candidates, in accordance with the performance of the blind detection operation on the PDCCH candidate.

2. The UE of claim 1, wherein the processing system is further configured to cause the UE to:
generate, for each PDCCH candidate of the first set of PDCCH candidates, a DMRS metric associated with the PDCCH candidate in accordance with a measurement of the DMRS associated with the PDCCH candidate; and
include the PDCCH candidate in the second set of PDCCH candidates in accordance with the DMRS metric associated with the PDCCH candidate satisfying a threshold or with the DMRS metric associated with the PDCCH candidate being one of a threshold number of largest DMRS metrics generated in accordance with the first set of PDCCH candidates.

3. The UE of claim 2, wherein the DMRS metric includes a DMRS reference signal receive power (RSRP), an estimated DMRS signal to interference and noise ratio (SINR), a metric calculated in accordance with the DMRS RSRP, or a metric calculated in accordance with the DMRS SINR.

4. The UE of claim 1, wherein the processing system is configured to cause the UE to perform the two-stage PDCCH blind detection procedure further in accordance with a subcarrier spacing associated with the first set of PDCCH candidates, a frequency range associated with the first set of PDCCH candidates, a frequency band associated with the first set of PDCCH candidates, or a combination thereof.

5. The UE of claim 1, wherein the processing system is further configured to cause the UE to:
receive, from the network node, a message during an initialization process associated with establishment of a communication link between the UE and the network node, and wherein the message includes the indication.

6. The UE of claim 1, wherein the processing system is further configured to cause the UE to:
receive, from the network node, a medium access control (MAC) control element (MAC-CE) or downlink control information (DCI), and wherein the MAC-CE or the DCI includes the indication.

7. The UE of claim 1, wherein the processing system is further configured to cause the UE to:
transmit, to the network node, a message that indicates a blind detection capability of the UE, wherein the indication is received in accordance with the transmission of the message.

8. The UE of claim 1, wherein the processing system is further configured to cause the UE to:
receive, from the network node, a second indication to the UE to use a single-stage PDCCH blind detection procedure during a subsequent time period;
perform, in accordance with the second indication, the single-stage PDCCH blind detection procedure, the performance of the single-stage PDCCH blind detection procedure including:
performing, for at least one PDCCH candidate of a third set of PDCCH candidates, a blind detection operation on the PDCCH candidate; and
receive, from the network node, additional control information via a PDCCH candidate, from the third set of PDCCH candidates, in accordance with the performance of the blind detection operation on the PDCCH candidate.

9. The UE of claim 1, wherein the processing system is further configured to cause the UE to:
transmit, to the network node, an indicator that indicates a power mode of the UE, wherein the indication is received in accordance with the transmission of the indicator.

10. The UE of claim 1, wherein the processing system is further configured to cause the UE to:
identify the first set of PDCCH candidates in accordance with a first set of parameters associated with one or more control resource sets (CORESETs); and
identify the second set of PDCCH candidates in accordance with the measurements of the DMRSs associated with the first set of PDCCH candidates and a second set of parameters, and wherein the second set of parameters include a PDCCH blind detection limit, a non-overlapped control channel element (CCE) limit, or both.

11. The UE of claim 1, wherein the processing system is further configured to cause the UE to:
receive, from the network node, an indicator to the UE that an identifier (ID) associated with initializing a DMRS sequence is specific to the UE; and
perform the two-stage PDCCH blind detection procedure further in accordance with the indicator.

12. A method of wireless communication by a user equipment (UE), comprising:
receiving, from a network node, an indication to the UE to use a two-stage physical downlink control channel (PDCCH) blind detection procedure;
performing, in accordance with the indication, the two-stage PDCCH blind detection procedure, the performance of the two-stage PDCCH blind detection procedure including:
measuring, in a first stage of the two-stage PDCCH blind detection procedure, for each PDCCH candidate of a first set of PDCCH candidates, a demodulation reference signal (DMRS) associated with the PDCCH candidate; and
performing, in a second stage of the two-stage PDCCH blind detection procedure, and in accordance with the measurements of the DMRSs associated with the first set of PDCCH candidates, for at least one PDCCH candidate of a second set of PDCCH candidates from the first set of PDCCH candidates, a blind detection operation on the PDCCH candidate; and
receiving, from the network node, control information via a PDCCH candidate, from the second set of PDCCH candidates, in accordance with the performance of the blind detection operation on the PDCCH candidate.

13. The method of claim 12, further comprising:
generating, for each PDCCH candidate of the first set of PDCCH candidates, a DMRS metric associated with the PDCCH candidate in accordance with a measurement of the DMRS associated with the PDCCH candidate; and
including the PDCCH candidate in the second set of PDCCH candidates in accordance with the DMRS metric associated with the PDCCH candidate satisfying a threshold or with the DMRS metric associated with the PDCCH candidate being one of a threshold number of largest DMRS metrics generated in accordance with the first set of PDCCH candidates.

14. The method of claim 13, wherein the DMRS metric includes a DMRS reference signal receive power (RSRP), an estimated DMRS signal to interference and noise ratio (SINR), a metric calculated in accordance with the DMRS RSRP, or a metric calculated in accordance with the DMRS SINR.

15. The method of claim 12, wherein the performance of the two-stage PDCCH blind detection procedure is further in accordance with a subcarrier spacing associated with the first set of PDCCH candidates, a frequency range associated with the first set of PDCCH candidates, a frequency band associated with the first set of PDCCH candidates, or a combination thereof.

16. The method of claim 12, further comprising:
receiving, from the network node, a message during an initialization process associated with establishment of a communication link between the UE and the network node, and wherein the message includes the indication.

17. The method of claim 12, further comprising:
receiving, from the network node, a medium access control (MAC) control element (MAC-CE) or downlink control information (DCI), and wherein the MAC-CE or the DCI includes the indication.

18. The method of claim 12, further comprising:
transmitting, to the network node, a message that indicates a blind detection capability of the UE, wherein the indication is received in accordance with the transmission of the message.

19. The method of claim 12, further comprising:
receiving, from the network node, a second indication to the UE to use a single-stage PDCCH blind detection procedure during a subsequent time period;
performing, in accordance with the second indication, the single-stage PDCCH blind detection procedure, the performance of the single-stage PDCCH blind detection procedure including:
performing, for at least one PDCCH candidate of a third set of PDCCH candidates, a blind detection operation on the PDCCH candidate; and
receiving, from the network node, additional control information via a PDCCH candidate from the third set of PDCCH candidates, in accordance with the performance of the blind detection operation on the PDCCH candidate.

20. The method of claim 12, further comprising:
transmitting, to the network node, an indicator that indicates a power mode of the UE, wherein the indication is received in accordance with the transmission of the indicator.

21. The method of claim 12, further comprising:
identifying the first set of PDCCH candidates in accordance with a first set of parameters associated with one or more control resource sets (CORESETs); and
identifying the second set of PDCCH candidates in accordance with the measurements of the DMRSs associated with the first set of PDCCH candidates and a second set of parameters, and wherein the second set of parameters include a PDCCH blind detection limit, a non-overlapped control channel element (CCE) limit, or both.

22. The method of claim 12, further comprising:
receiving, from the network node, an indicator to the UE that an identifier (ID) associated with initializing a DMRS sequence is specific to the UE; and
performing the two-stage PDCCH blind detection procedure further in accordance with the indicator.

23. A network node for wireless communication, comprising:
a processing system that includes one or more processors and one or more memories coupled with the one or more processors, the processing system configured to cause the network node to:
transmit, to a user equipment (UE), an indication to the UE to use a two-stage physical downlink control channel (PDCCH) blind detection procedure;
transmit, to the UE, and in accordance with a first stage of the two-stage PDCCH blind detection procedure, one or more demodulation reference signals (DMRSs) associated with a first set of PDCCH candidates of the first stage; and
transmit, to the UE, and in accordance with a second stage of the two-stage PDCCH blind detection procedure, control information via a PDCCH of a second set of PDCCH candidates identified from the first set of PDCCH candidates at the UE in accordance with the second stage.

24. The network node of claim 23, wherein the processing system is further configured to cause the network node to:
transmit, to the UE, a message during an initialization process associated with establishment of a communication link between the UE and the network node, the message including the indication;
transmit, to the UE, a medium access control (MAC) control element (MAC-CE) that includes the indication; or
transmit, to the UE, downlink control information (DCI) that includes the indication.

25. The network node of claim 23, wherein the processing system is further configured to cause the network node to:
receive, from the UE, a message that indicates a blind detection capability of the UE or an indicator that indicates a power mode of the UE, wherein the indication is transmitted in accordance with the message or the indicator.

26. The network node of claim 23, wherein the processing system is further configured to cause the network node to:
transmit, to the UE, an indicator to the UE that an identifier (ID) associated with initializing a DMRS sequence is specific to the UE.

27. A method of wireless communication by a network node, comprising:
transmitting, to a user equipment (UE), an indication to the UE to use a two-stage physical downlink control channel (PDCCH) blind detection procedure;
transmitting, to the UE, and in accordance with a first stage of the two-stage PDCCH blind detection procedure, one or more demodulation reference signals (DMRSs) associated with a first set of PDCCH candidates of the first stage; and
transmitting, to the UE, and in accordance with a second stage of the two-stage PDCCH blind detection procedure, control information via a PDCCH of a second set of PDCCH candidates identified from the first set of PDCCH candidates at the UE in accordance with the second stage.

28. The method of claim 27, further comprising:
transmitting, to the UE, a message during an initialization process associated with establishment of a communication link between the UE and the network node, the message including the indication;
transmitting, to the UE, a medium access control (MAC) control element (MAC-CE) that includes the indication; or
transmitting, to the UE, downlink control information (DCI) that includes the indication.

29. The method of claim 27, further comprising:
receiving, from the UE, a message that indicates a blind detection capability of the UE or an indicator that indicates a power mode of the UE, wherein the indication is transmitted in accordance with the message or the indicator.

30. The method of claim 27, further comprising:
transmitting, to the UE, an indicator to the UE that an identifier (ID) associated with initializing a DMRS sequence is specific to the UE.
